(19) United States
(12) Patent Application Publication
(10) Pub. No.: US 2018/0198117 A1
(43) Pub. Date: Jul. 12, 2018

(54) PROCESS FOR MANUFACTURING AN ELECTRODE, ELECTRODE THUS MANUFACTURED AND ELECTROCHEMICAL SYSTEM COMPRISING SAID ELECTRODE

(71) Applicant: Commissariat a L'Energie Atomique et aux Energies Alternatives, Paris (FR)

(72) Inventor: Pascal TIQUET, Grenoble (FR)

(73) Assignee: Commissariat A L'Energie Atomique et aux Energies Alternatives, Paris (FR)

(21) Appl. No.: 15/128,848

(22) PCT Filed: Mar. 23, 2015
(86) PCT No.: PCT/EP15/56144

§ 371 Date: Sep. 23, 2016

(51) Int. Cl. H01M 4/139; H01M 4/04; H01M 4/62; C09D 11/04; C09D 11/14; C09D 11/52

(52) U.S. Cl. CPC H01M 4/139; H01M 4/0416; H01M 4/625; B82Y 30/00; C09D 11/14; C09D 11/52; C09D 11/04

(57) ABSTRACT

A method for manufacturing an electrode with an integrated separator, the thereby manufactured electrode, and an electrochemical system such as a lithium ion accumulator including such an electrode.

### TECHNICAL FIELD

The invention relates to a method for manufacturing an electrode.

More specifically, the invention relates to a method for manufacturing an electrode comprising as an electrochemically active material a composite material comprising nano-objects, notably carbon nano-objects.

Still more specifically, the invention relates to a method for manufacturing an electrode comprising as an electrochemically active material a composite material comprising carbon nano-objects and nano-objects of a material other than carbon, such as silicon.

This composite material may thus be also designated as a nanocomposite material.

The invention in particular relates to a method for manufacturing an electrode comprising as an electrochemically active material a composite material comprising carbon nano-objects, and nanoparticles or submicron particles of an active material or a negative or positive electrode active material of a lithium-ion battery, accumulator such as silicon, LiFePO₄, LiMnPO₄, or LiNiPO₄.

Still more particularly, the invention relates to a method for manufacturing an electrode comprising as an electrochemically active material a composite material comprising carbon nanotubes («CNT») and silicon nanoparticles or silicon submicron particles.

The invention further relates to the electrode thus manufactured.

This electrode may notably be a negative electrode, of an electrochemical system with an organic, non-aqueous electrolyte such as a rechargeable electrochemical battery with an organic electrolyte, notably a lithium battery or still more specifically a lithium-ion battery.

The invention also relates to an electrochemical system, for example a lithium-ion battery, accumulator comprising such electrodes.

The technical field of the invention may generally be defined as that of electrodes comprising as an electrochemically active material a composite material comprising carbon and another material such as silicon.

### STATE OF THE PRIOR ART

Electrodes of rechargeable accumulators, batteries, with a conventional organic electrolyte contain an electrochemically active material which forms a receiving structure in which the cations, for example the lithium cations are inserted and de-inserted during the cycling. Each electrode is obtained by depositing an ink, a suspension or slurry on a current collector, said ink, suspension, or slurry containing the active material, optionally conductive additives, a binder such as a polymer, and a solvent.

The ink deposited on the collector is then dried for removing the solvent.

The drying may be carried out by evaporation, vaporization of the solvent.

Thus, document WO-A1-2012/056389 describes a method for manufacturing electrodes of a lithium-ion accumulator, battery, in which the active materials of the electrodes are mixed with a binder in order to form a solution of the binder, an organic carbonate is added to the solution of binder in order to form a suspension or slurry, the current collector is coated with the suspension, and the coating is dried on the current collector by evaporating the organic carbonate.

Document WO-A1-2012/049967 describes, according to the abstract, a method for manufacturing a negative electrode for a battery, accumulator with a non-aqueous electrolyte in which a mixture comprising a vinylidene fluoride polymer as well as a sulfur-containing organic compound, an active electrode material and a solvent, is applied on a current collector, and the current collector coated with this mixture is then dried by evaporating the solvent.

Document FR-A1-2965108 relates to a method for manufacturing an electrode for a lithium-ion battery in which an ink comprising an active material, a polymeric binder and an electron conductor is deposited on a current collector, and the ink is then dried by evaporation of the solvent, for example in an oven with air flow at 60° C.

Drying by evaporation proves to be limiting when the active material or electron conductive particles are nanometric since the surface tensions are proportional to the developed surface area of the nanoparticles, and the capillary depressions at the time of the evaporation are proportional to the reciprocal of the radius of the particles.

This leads to disorganization of the active materials and of the nanometric electron conductors, with the consequence of a loss of electronic connectivity and a reduction of the free surfaces in contact with the electrolyte.

Another drying technique is the freeze-drying technique which is widely used in the agrifood and pharmaceutical field but much less in the field of accumulators.

Document WO-A1-2012/043398 relates to a method for drying a pair of electrodes, for example for a rechargeable lithium-ion battery, in which a pair of electrodes is dried by using a freeze-drying technique, and a chamber containing the pair of electrodes is dried by using a freeze-drying technique.

Cross-linking is also a technique, other than drying, which allows solidification of an electrode.

From among the documents which deal with cross-linking within the scope of the manufacturing of the electrodes, mention may notably be made of documents US-A1-2011/0305970, and EP-A2-182451.

Document US-A1-2011/0305970 describes a hydrogel insoluble in water, prepared by a chemical cross-linking reaction between a polymer such as a PVA, chitosan and gelatin, and an organic cross-linking agent such as glutaraldehyde. This hydrogel may notably be used as a binder for electrodes.

Document EP-A2-0 182 451 relates to an aqueous gel, based on a polymer such as PVA, optionally cross-linked.

The goal pursued in documents US-A1-2011/0305970 and EP-A2-0 182 451 is to cross-link polymers in order to make them insoluble in water and in the other electrolytes of batteries.

These documents do not describe the gelling of an ink after its coating, for example on a current collector, in order to manufacture an electrode, and they do not mention the fundamental problems which are those of preserving the organization of the active material during the drying, and of the flexibility of the electrode.

Furthermore, it is known that carbon nanotubes have been used as additives for negative electrode or positive electrode active materials, or as an anode active material with view to improving the performances of lithium-ion accumulators.

Thus, the document of LIU et al., “Carbon nanotube (CNT)-based composites as electrode material for rechargeable Li-ion batteries: A review”, Composites Science and Technology, 72 (2012), 121-144 [1], describes nanocomposite materials comprising single-walled carbon nanotubes and various cathode materials such as LiCoO₂, LiFePO₄, LiMn₂O₄, or further intrinsically conductive polymers.

This document further indicates that the carbon nanotubes may be used as an anode material instead of graphite, and describes nanocomposite anode materials comprising single-walled carbon nanotubes and various anode active materials such as Sn; Bi; SnSb; CoSb₃; Ag, Fe, and Sn; TiO₂; SnO₂; Li₄Ti₅O₁₂; oxides of transition metals such as TiO₂, Co₃O₄, CoO, and Fe₃O₄; and finally silicon.

The accumulators which use the materials listed in document [1] also have insufficient performances.

Moreover, it is known that in the case of negative electrode active materials in the Li/ion technology, a possibility for improving the performances thereof is to replace graphite with another material with better capacity like tin, or silicon.

With a theoretical capacity estimated to be 3,579 mAh/g (for Si→Li_{3.75}Si), the silicon represents a desirable alternative to carbon as a negative electrode material. Nevertheless, this material has a major drawback preventing its use. Indeed, the volume expansion of the silicon particles which may attain up to 400% during charging upon insertion of lithium (Li-ion system) causes degradation of the material with cracking of the particles and detachment of the latter from the current collector.

This weakening of the material is presently difficult to control and leads to low cyclability of the electrode.

It has been shown that the use of these materials, such as silicon, as nanometric powders may give the possibility of limiting the extent of these degradation phenomena, and of attaining improved reversibility for capacities close to the theoretical values.

However, the use of nanometric powders of silicon is rapidly confronted with problems for maintaining electron percolation within the electrode.

In order to provide a material capable of maintaining the integrity of the electrode after repeated charging-discharging cycles and of overcoming the problems inherent to silicon, much research work has therefore, for several years, been dealing with materials in which the alternative material, such as silicon, is coupled with carbon, these are in particular silicon/carbon composite materials in which, generally, the silicon is dispersed in a carbon matrix.

The purpose of these materials is to combine the good cyclability of carbon with an extra supply of capacity due to the addition of silicon.

However, accumulators, batteries such as lithium-ion accumulators, batteries which comprise such materials again have, there also, insufficient performances.

Document CN-A-101439972 [2] describes particles of a silicon-carbon composite material which comprises carbon nanotubes bound to silicon nanoparticles with amorphous carbon.

This composite material is prepared by a method comprising the following successive steps:
the silicon nanoparticles and the carbon nanotubes are dispersed in a solvent such as water or ethanol, in the presence of a dispersant;
the solvent and the dispersant are removed in order to thereby obtain particles of a composite material comprising silicon nanoparticles and carbon nanotubes;
the particles of this composite material are put into contact with a solution of an amorphous carbon precursor in an organic solvent;
the solvent is removed from the precursor and carbonization of the precursor is carried out by a chemical vapor deposition method (CVD).

The amorphous carbon precursor is an organic compound selected from among resins, asphalts, sugars, benzene and naphthalene.

In this document, a simple statistical mixture of silicon nanoparticles and of carbon nanotubes is carried out, without any occurrence of a self-organization of the silicon nanoparticles around the carbon nanotubes, consequently, the performances of lithium-ion accumulators, batteries comprising the material prepared in this document are still insufficient.

Indeed, the statistical mixture is defined as an isoprobability of assembling a carbon nanotube (CNT) to a silicon particle (P_{CNT-Si}), or of assembling a silicon particle to a carbon nanotube (P_{Si-CNT}), or of assembling a silicon particle to a silicon particle (P_{Si-Si}), or of assembling a carbon nanotube to a carbon nanotube (P_{CNT-CNT}). The statistical mixture corresponds to equality of the assembling probabilities, i.e. P_{CNT-Si}˜P_{Si-CNT}˜P_{Si-Si}˜P_{CNT-CNT}.

The statistical mixture is not optimum, it does not allow generation of a «self-assembled» structure. In order to obtain a «self-assembled» structure, it is required that P_{Si-CNT}>>P_{CNT-CNT}>>P_{Si—Si}.

It would therefore be advantageous to manufacture an electrode from a nanocomposite material comprising nano-objects made of at least one first electron conducting material and nano-objects or submicron objects made of at least one second material different from the first material, notably a nanocomposite material comprising carbon nano-objects, in particular carbon nanotubes, and nano-objects of a material other than carbon, in particular silicon nanoparticles, in which the nano-objects are distributed in an organized way and not in a statistical, random way, and preferably according to a «self-assembled» structure.

More exactly, it would be advantageous to manufacture an electrode from a composite material in which nanoparticles of silicon or of another active material are organized, for example self-assembled, around carbon nanotubes.

However, when an electrode is prepared from a composite material comprising nano-objects made of at least one first electron conductive material, and nano-objects or submicron objects made of at least one second material different from the first material, in which the nano-objects are organized, for example self-assembled, it was seen above that this organization, assembling, is lost during the step for drying the ink by evaporation.

Therefore considering the foregoing, there exists a need for a method for manufacturing an electrode from a composite material comprising organized nano-objects—notably a nanocomposite material comprising carbon nano-objects, such as carbon nanotubes and nano-objects of a material other than carbon—which gives the possibility of retaining, in the manufactured electrode, the organization of the nano-objects initially present in the starting composite material.

Notably there exists a need for such a method in which the initial organization of the nano-objects is not disturbed during a drying step applied during the manufacturing of the electrode.

There further exists a need for a manufacturing method which allows manufacturing of flexible, resistant electrodes and having excellent electrochemical and mechanical properties.

There also exists a need for such a method for manufacturing an electrode which is simple, reliable and which includes a limited number of steps.

There also exists a need for such a preparation method which gives the possibility of obtaining an electrode which, when it is used in an accumulator, battery such as a lithium-ion accumulator, battery gives the possibility of obtaining improved performances notably as to the discharge capacity of these accumulators, batteries.

Further there exists a need for a method which gives the possibility of preparing an electrode which may resist increases in volume during the charging of materials such as silicon.

The goal of the present invention is to provide a method for manufacturing an electrode of an electrochemical system which inter alia meets these needs, and which notably meets the requirements and criteria listed above.

The goal of the present invention is further to provide a method for manufacturing an electrode of an electrochemical system which does not have the drawbacks, defects, limitations and disadvantages of the methods for manufacturing electrodes of the prior art and which solves the problems of the methods of the prior art.

### SUMMARY OF THE INVENTION

This goal, and further other ones, are attained, according to the invention by a method for manufacturing an electrode comprising a composite material comprising nano-objects, said method comprising the following successive steps:

a) a sheet or plate made of a porous cellulose material comprising a first face (side) and a second face separated by a thickness is positioned on a supporting plate, the second face (side) being in contact with the supporting plate;

b) a suspension, paste (slurry), or ink comprising a composite material, a polysaccharide, optionally electron conductive additive(s), and a solvent, is prepared, said composite material comprising nano-objects made of at least one first electron conductive material and nano-objects or submicron objects made of at least one second material different from the first material; and said nano-objects made of at least one first electron conductive material and said nano-objects or submicron objects made of at least one second material different from the first material, being distributed in an organized and non-statistical, non-random way, in said composite material;

c) this suspension, paste (slurry) or ink is deposited, coated or printed on the first face of the sheet, the viscosity of the suspension, paste (slurry) or ink being such that the sheet absorbs the ink exclusively on a portion of its thickness, for example half of its thickness;

d) as soon as the end of step c), without waiting for the drying of the deposited suspension, paste (slurry) or ink, a current collector such as a grid is applied, deposited on the first face coated with ink of the sheet, whereby the current collector is at least partly embedded in the deposited ink;

e) the first face, coated with ink, of the sheet on which the current collector is deposited and embedded, is put into contact with an aqueous cross-linking solution of the polysaccharide, containing at least one water-soluble salt capable of releasing monovalent, divalent or trivalent cations, whereby the ink is cross-linked, gelled;

f) the sheet and the supporting plate is subject to a freeze-drying treatment;

g) the sheet is separated from the supporting plate.

Advantageously, the nanocomposite material comprises nanostructures each consisting of the nano-objects made of at least one first electron conductive material on which are self-assembled and attached the nano-objects or the submicron objects made of at least one second material different from the first material, and said nanostructures are homogeneously distributed in the material.

The method according to the invention applies specific materials and comprises a specific sequence of steps which has never been described, nor even suggested in the prior art.

In particular, the method according to the invention is defined by the use of a specific material, i.e. a porous cellulose material as a basis for the manufacturing of the electrode, and by the use of a specific composite material as an active material of the electrode according to the invention.

Indeed, in the composite material used for the preparation of the electrode according to the invention, the nano-objects or submicron objects are distributed in an organized way, as this was defined above herein, and not in a statistical, random way.

This organization of the nano-objects or submicron objects may notably be defined by the fact that these nano-objects or submicron objects form particular nanostructures which are homogenously distributed in the material.

This organization is retained in the electrode obtained at the end of the method according to the invention because of the cross-linking carried out during step e), and of the application of a freeze-drying technique for achieving drying of the sheet and of the supporting plate during step f).

By «homogeneously distributed», is generally meant that the nanostructures are uniformly, regularly distributed, in the whole (throughout the) volume of the material and that their concentration, presence are substantially the same in the whole volume of the material, in all the portions of the latter.

It should be noted that the second material is not necessarily an electron conductive (conducting) material, but often this may be an insulating material.

Advantageously, the nano-objects made of at least one first electron conducting material may be marked (labelled) with a first molecule, the nano-objects or the submicron objects made of at least one second material different from the first material may be marked with a second molecule (generally different from the first molecule) and are self-assembled and attached on the nano-objects made of at least one first material by specific recognition between the first molecule and the second molecule.

By “marked” (labelled), is generally meant that the first molecule, a so called first marking molecule, is attached on the nano-objects made of a first material (generally at least on the external surface thereof) and that the second molecule, a so called second marking molecule, is attached on the nano-objects made of a second material (generally at least on the external surface thereof).

Let us specify that the specific recognition phenomenon between molecules which may also be called a molecular recognition phenomenon is well-known to the man skilled in the art, is on the basis of biological systems and is used in many applications in biotechnology.

This recognition, for example between macromolecules (proteins, nucleic acids) or between macromolecules and smaller size organic molecules or atoms is ensured, in the very large majority of the cases, via several non-covalent chemical bonds.

The purification, analysis and detection methods for such macromolecules also apply such specific recognitions. For example, the latter involve the pair (couple) (strept)avidin/biotin; protein A/immunoglobulin; protein G/immunoglobulin; antibody/antigen or antibody/epitope pairs like the poly-His peptide and a specific antibody of this peptide or the C-terminal fragment of the Myc protein and the monoclonal antibody 9E10; the enzyme/substrate pairs like the glutathione S-transferase/glutathione pair; or the nucleotide sequence/complementary nucleotide sequence pairs.

These non-covalent interactions involve ionic bonds, hydrogen bonds, hydrophobic bonds and/or Van der Waals forces.

The first marking molecule and the second marking molecule constitute what may be called a specific recognition pair between molecules or a molecular recognition.

The specific recognition pair between molecules or molecular recognition pair which may be applied according to the invention is not limited and may be notably selected from the specific recognition pairs or molecular recognition pairs already mentioned above ((strept)avidin/biotin etc.).

Preferably, the first molecule is biotin, and the second molecule is avidin or streptavidin.

Advantageously, each of the nanostructures has a size which is at least equal to the size of each of the nano-objects made of at least one first electron conductive material, for example to the length of the carbon nanotubes.

Each of the nanostructures may thus have a size from 1 μm to 10 μm. The content of nano-objects made of at least one first electron conductive material and of nano-objects or submicron objects made of at least one second material different from the first material respectively is from 1% to 40%, and from 60% to 99% by mass.

Advantageously, the first electron conductive material is selected from among carbon, metals such as aluminium and copper, and metal alloys such as aluminium alloys and copper alloys, for example aluminium and copper alloys.

Advantageously, the second material may be selected from among silicon; metals such as tin; metal alloys; sulfur; metal oxides such as alumina; positive electrode active materials of lithium-ion accumulators, batteries such as LiFePO₄, LiFeSO₄F, LiCoO₂, LiNiO₂, LiFeₓMn_{y}PO₄, LiMnₓNi_{y}O₄, LiMnₓNi_{y}Nb_{z}O₄, LiNiₓMn_{y}Al_{z}O₂, LiCoₓNi_{y}Mn_{z}O₂, titanium phosphates, Li₂CoSiO₄, LiMnₓO₄, LiNiₓPO₄, LiCoₓO₂, LiNiₓCo_{y}O₂, sodium, vanadium oxide, TiS₂, TiO_{X}S_{Z}, Li₂MnO₃; and negative electrode active materials of lithium-ion accumulators, batteries, such as graphite, titanates like Li₄Ti₅O₁₂, H₂Ti₁₂O₂₅, Si, Sn, niobium oxides LiₓNb_{y}O_{z}, VBO₃, TiSnSb, Li₂SnO₃, Ni—Si, TiO₂, and SnCo.

Advantageously, the nano-objects made of at least one first material may be selected from among nanotubes, nanowires, nanofibers, nanoparticles, nanocrystals made of at least one first material, and mixtures thereof; and nano-objects or submicron objects made of at least one second material may be selected from among nanotubes, nanowires, nanofibers, nanoparticles, submicron particles, nanocrystals made of at least one second material, and mixtures thereof.

In a first preferred embodiment, the first material is carbon, and the second material is a material other than carbon.

Then, advantageously, in this first embodiment, the carbon nano-objects may be selected from among carbon nanotubes, carbon nanowires, carbon nanofibers, carbon nanoparticles, carbon nanocrystals, carbon blacks, and mixtures thereof; and the nano-objects or submicron objects made of at least one material other than carbon may be selected from among nanotubes, nanowires, nanofibers, nanoparticles, submicron particles, nanocrystals made of at least one material other than carbon, and mixtures thereof.

Preferably, the carbon nano-objects may be selected from carbon nanotubes and carbon nanofibers; and the nano-objects or submicron objects made of at least one material other than carbon may be silicon nanoparticles or submicron particles.

The carbon nanotubes may be selected from single-walled carbon nanotubes, and multi-walled carbon nanotubes such as dual-walled carbon nanotubes.

Advantageously, the nano-objects or the submicron objects made of at least one material other than carbon, such as silicon nanoparticles or silicon submicron particles, may have a spherical or spheroidal shape.

In a second embodiment, the first material is aluminium or copper, and the second material is a material other than aluminium or copper such as silicon.

Then, advantageously, in this second embodiment, the aluminium or copper nano-objects may be selected from aluminium or copper nanowires; and the nano-objects or submicron objects made of at least one material other than aluminium or copper may be selected from among nanotubes, nanowires, nanofibers, nanoparticles, submicron particles, nanocrystals made of at least one material other than aluminium or copper such as silicon.

It should be noted that it is more advantageous to use carbon nanotubes, which give the possibility of obtaining flexible three-dimensional networks (“cooked spaghetti”) while metal nanowires give rigid three-dimensional networks (“knitting needles”).

Advantageously, the ratio of the number of nano-objects or submicron objects made of at least one second material, for example made of silicon, to the number of nano-objects made of at least one first material, for example made of carbon, such as carbon nanotubes, is less than or equal to 1/100.

Advantageously, the polysaccharide may be selected from among pectins, alginates, alginic acid, and carrageenans.

Advantageously, the composite material used in the method according to the invention appears as a powder.

Generally, this powder is an extremely airy, expansed, foamed (scarcely) not very dense powder with a large bulk volume, generally greater than 18 liter/kg of powder.

Advantageously, this powder has an average grain size, which generally corresponds to the average size of the nanostructures or clusters, bunches comprised between 1 μm and 100 μm, for example 20 μm, a specific surface area comprised between 10 m²/g and 50 m²/g, and a density comprised between 2.014 g/cm³ and 2.225 g/cm³.

The composite material applied in the method according to the invention is not known from the prior art.

The composite material applied in the method according to the invention has a very specific structure, with nano-objects made of at least one first electron conductive material and nano-objects or submicron objects made of at least one second material different from the first material; said nano-objects made of at least one first electron conductive material and said nano-objects or submicron objects made of at least one second material different from the first material being distributed in an organized and non-statistical, random way, in said composite material.

Preferably, said composite material comprises nanostructures each consisting of the nano-objects made of at least one first electron conductive material on which are self-assembled and attached the nano-objects or submicron objects made of at least one second material different from the first material, and said nanostructures being homogenously distributed in the material.

As this has already been specified above, the nano-objects made of at least one first electron conductive material may be marked with a first molecule, the nano-objects or submicron objects made of at least one second material different from the first material may be marked with a second molecule and are then self-assembled and attached on the nano-objects made of at least one first material by specific recognition (molecular recognition) between the first molecule and the second molecule.

Such a structure for a nanocomposite material based on nano-objects such as carbon nano-objects, for example carbon nanotubes, used for the manufacturing of an electrode, is totally novel.

The structure or organization of the composite material applied according to the invention may notably be defined as a specific “self-assembled” structure or organization in which around and on nano-objects made of a first material, such as carbon, for example carbon nanotubes, which are preferably marked with a first molecule, will agglomerate, aggregate, self-assemble, bind, attach, to the nano-objects made of a second material, for example made of a material other than carbon, such as silicon nanoparticles, these nano-objects made of a second material being preferably marked with a second molecule.

This binding, attachment, may preferably be ensured by a very particular phenomenon, i.e. a specific recognition phenomenon between the first molecule and the second molecule which may respectively mark the nano-objects made of a first material and the nano-objects made of a second material.

The nanocomposite material applied according to the invention fundamentally differs from nanocomposite materials and notably silicon/carbon nanocomposite materials applied in the prior art in that in the material applied according to the invention, the nano-objects made of a first material for example the carbon nano-objects such as CNTs, and the nano-objects made of a second material, for example made of a material other than carbon, such as silicon, are organized, notably self-assembled, while in the materials of the prior art, the nano-objects are randomly, statistically distributed.

In none of the applied materials of the prior art, such a good dispersion of the nano-objects with such a regular distribution thereof can be obtained.

Furthermore, in the material according to the invention, the organization of the nano-objects made of a first material, for example of the carbon nano-objects and of the nano-objects made of a second material, of a material other than carbon, such as silicon, is preferably a very particular so called «self-assembled» organization, in which the nano-objects made of a second material, such as a material other than carbon are self-assembled, attached around, on nano-objects made of a first material, for example carbon nano-objects, such as CNTs which are used as an electron conductive backbone.

The nano-objects made of a first material, for example the carbon nano-objects, such as CNTs, generally form a three-dimensional network.

This binding, attachment, may preferably be ensured by a very particular phenomenon, i.e. a specific recognition phenomenon between the first molecule and the second molecule which, preferably may respectively mark the nano-objects made of a first material and the nano-objects made of a second material. The binding by this particular phenomenon, preferably applied according to the invention, of molecular recognition is highly reliable, uniform and very accurate.

Compared with materials in which the nano-objects are not organized, notably with a self-assembled structure, for example due to molecular recognition, and are distributed in a statistical, random way, the composite material applied in the method according to the invention has improved performances for example in cycling, in rapid charging, when it is applied in a lithium-ion accumulator, battery.

The structure, organization, notably self-assembled, for example by molecular recognition, of the material applied in the method according to the invention, unlike the materials in which the nano-objects are not organized in this way, gives the possibility of preserving electron conduction and accessibility to the electrolyte, even when the nano-objects or submicron objects made of a second material, for example made of a material other than carbon, notably when these are silicon nanoparticles, experience an increase in their volume.

The structure, organization, notably self-assembled, of the composite material applied in the method according to the invention, also gives the possibility of preserving the connectivity of the nano-objects or submicron objects made of at least one second material, for example made of a material other than carbon such as silicon nanoparticles to the electron conductive three-dimensional backbone, network.

The organization of the material applied in the method according to the invention is preserved, and is not modified, during individual increase in the volume of the nano-objects made of a second material, such as a material other than carbon (in the case when the first material is carbon), such as silicon nanoparticles.

Importantly, the organization of the material applied in the method according to the invention is preserved during the preparation of the ink which contains a polysaccharide as a binder, during the cross-linking step and finally, surprisingly, during the drying step because this drying step is achieved, according to the invention, by freeze-drying and not by evaporation.

Advantageously, the porous cellulose (cellulosic) material may be paper, preferably blotting paper, consisting of cellulose microfibers and not containing any additive such as a binder.

Advantageously, the porous cellulose (cellulosic) material sheet may have a thickness from 50 μm to 500 μm, preferably 180 μm, and a basis weight of less than or equal to 80 g/m², preferably from 20 to 80 g/m².

Advantageously, the suspension, paste (slurry) or ink may have a dry extract greater than or equal to 70%, and a viscosity at rest greater than or equal to 500 Pa·s, preferably from 500 Pa·s to 700 Pa·s (generally measured at 20° C.).

Preferably, the polysaccharide which plays the role of a binder of the ink is selected from among alginates.

Preferably, the solvent comprises 50% of water or more by volume, still preferably the solvent consists of water, i.e. it comprises 100% of water by volume. The water is generally deionized water.

Advantageously, a suspension, paste (slurry) or ink layer with a thickness from 100 μm to 1,000 μm, for example from 200 μm to 500 μm may be deposited on the first face of the sheet.

Advantageously, the optional electron conductor may be selected from among graphite, graphene, carbon fibers, carbon fiber precursors like PANs (polyacrylonitriles), conductive polymers, microwires and nanowires of metals such as microwires and nanowires of copper and silver, and mixtures thereof.

The invention further relates to an electrode manufactured by the method according to the invention, as it was described above.

The electrode according to the invention, advantageously also integrates a separator and may therefore be described as an electrode with an integrated separator.

The electrode according to the invention, and this ensues from the method used for preparing it, therefore effectively plays both the role of an electrode but also the role of a separator.

Indeed, the portion of the thickness of the sheet (for example half the thickness of the sheet), from the first face, in which the ink has been absorbed and then cross-linked, gelled and finally dried by freeze-drying, plays the role of an electrode as such, a collector being applied on the first face, while the portion of the thickness of the sheet (for example also half the thickness of the sheet) in which the ink has not been absorbed plays the role of a separator.

There, this is one of the advantages of the method according to the invention of allowing simultaneous preparation in a single go of the electrodes and separators, while in the prior art, the electrodes and the separators are manufactured separately and then assembled.

The method according to the invention therefore causes significant savings in terms of times and costs.

The thereby manufactured electrode inherently has all the advantageous properties related to the composite material which it contains as an electrochemically active material, which are notably due to the organization of the nano-objects or submicron objects.

All the advantageous properties of the composite material notably due to this organization are entirely preserved, saved, in the electrode obtained at the end of the method according to the invention by means of the cross-linking achieved during step e) of the method according to the invention, and by means of the use of a freeze-drying technique instead for example of another drying technique, such as an evaporation technique for achieving drying of the sheet and of the supporting plate during step f) of the method according to the invention.

When the sheet is put into contact with an aqueous cross-linking solution of the polysaccharide containing at least one salt soluble in water, which may release monovalent, divalent or trivalent cations, the ink absorbed on a portion of the thickness of the cellulose material sheet, for example on one half of the thickness of the sheet of the cellulose material is cross-linked, gelled. Next the sheet coated with ink onto which the current collector is deposited and embedded is dried by a freeze-drying technique.

The gelling and the organization of the polysaccharide of the ink by the cations, for example by the calcium cations, followed by drying by freeze-drying leads to stratification inside the sheet made of cellulose material, for example made of blotting paper, forming an electrode. This stratification would occur because of a so called «egg box» mechanism of the polysaccharide such as an alginate.

Notably by means of this stratification of the electrode, the performances of the electrode are improved as compared with an electrode manufactured from an ink which is not cross-linked and which is not dried by freeze-drying but by evaporation (FIG. 8).

Indeed, the polysaccharide such as an alginate thereby organized contributes to the insertion of lithium into the structure of the electrode (FIG. 4).

The electrodes according to the invention are particularly adapted and designed for active materials which swell upon insertion of the lithium, like silicon and tin.

The basis weight of active material of the electrode according to the invention is generally greater than or equal to 1.5 mg of material/cm².

The low density of the cellulose material sheet which is generally less than or equal to 80 g/m³ and which generally does not comprise any additive or binder even gives the possibility of obtaining basis weights of active material which may range up to 10 mg/cm² while preserving great flexibility of the electrode without any occurrence of cracking.

The electrode according to the invention notably because of the cellulose material sheet from which it is manufactured, has greater flexibility than the electrodes of the prior art which are not manufactured from a sheet made of such a material.

It has been shown (FIG. 9) that this greater flexibility of the electrode according to the invention, prepared by the method according to the invention, reduces the irreversible losses, for example by a factor 2, of a lithium-ion accumulator, battery, comprising the electrode according to the invention as compared with a lithium-ion accumulator, battery, comprising an electrode manufactured in a conventional way.

This electrode may be a positive electrode or a negative electrode.

The invention further relates to an electrochemical system comprising such an electrode.

This electrochemical system may be a system with a non-aqueous electrolyte such as a rechargeable electrochemical accumulator, battery, with a non-aqueous electrolyte.

Preferably, this electrochemical system is a lithium-ion accumulator, battery, for example a button cell.

This electrochemical system such as a lithium-ion accumulator, battery, inherently has all the advantageous properties related to the electrode which it contains.

The manufacturing of an accumulator, battery, comprising at least one electrode according to the invention is greatly simplified since, as each electrode also integrates a separator, in fact there are only two electrodes according to the invention, i.e. a positive electrode and a negative electrode, to be wound or stacked for manufacturing the accumulator and no longer an electrode, a separator and then another electrode. Consequently, the final structure of the accumulator, battery, is also greatly simplified.

### BRIEF DESCRIPTION OF THE DRAWINGS

The invention will be better understood upon reading the detailed description which follows, given as an illustration and not as a limitation with reference to the appended drawings wherein:

FIG. 1 is a schematic lateral sectional view of the mixing device used for dispersing the nano-objects made of at least one first material like carbon nano-objects, such as carbon nanotubes.

FIG. 2 is a photograph, taken with a scanning electron microscope SEM which shows the composite material used for manufacturing the electrode according to the invention with the active material powder, i.e. silicon nanoparticles, self-assembled by molecular recognition on carbon nanotubes.

The scale drawn on FIG. 2 represents 10 μm.

FIG. 3 is a diagram which shows the successive steps (A, B, C, D, E) of the method for manufacturing an electrode according to the invention.

FIG. 4 is a photograph, taken with a scanning electron microscope SEM which shows the stratification of an electrode according to the invention obtained by gelling and freeze-drying of an ink inside a cellulose reinforcement of the blotting paper sheet type.

The scale drawn in FIG. 4 represents 1 μm.

FIG. 5 is a photograph, taken with a scanning electron microscope SEM which shows a current collector of an electrode according to the invention consisting of a copper (or aluminium) grid embedded on one face of a blotting paper sheet coated with ink and then gelled and freeze-dried.

The scale drawn in FIG. 5 represents 200 μm.

FIG. 6 is a photograph, taken with a scanning electron microscope SEM which shows the structure of an electrode with integrated separator according to the invention prepared on a cellulose reinforcement, i.e. a blotting paper sheet.

The scale drawn in FIG. 6 represents 10 μm.

FIG. 7 is a schematic lateral sectional view of an accumulator in the form of a button cell comprising a negative electrode to be tested such as an electrode according to the invention or else a comparative electrode.

FIG. 8 is a graph which gives the specific capacity (in mAh/g) in discharge versus the number of cycles during the test (Example 4) according to a C/20 cycling of three button cells as the one illustrated in FIG. 7, the positive electrode of which consists of lithium metal and the negative electrode of which is an electrode according to the invention prepared in Example 3. The three cells according to the invention include electrodes with respective basis weights of 1.5 mg (square markers ▪); 3 mg (Saint Andrew's cross X markers); and 5 mg (triangle markers ▴) of active material/cm².

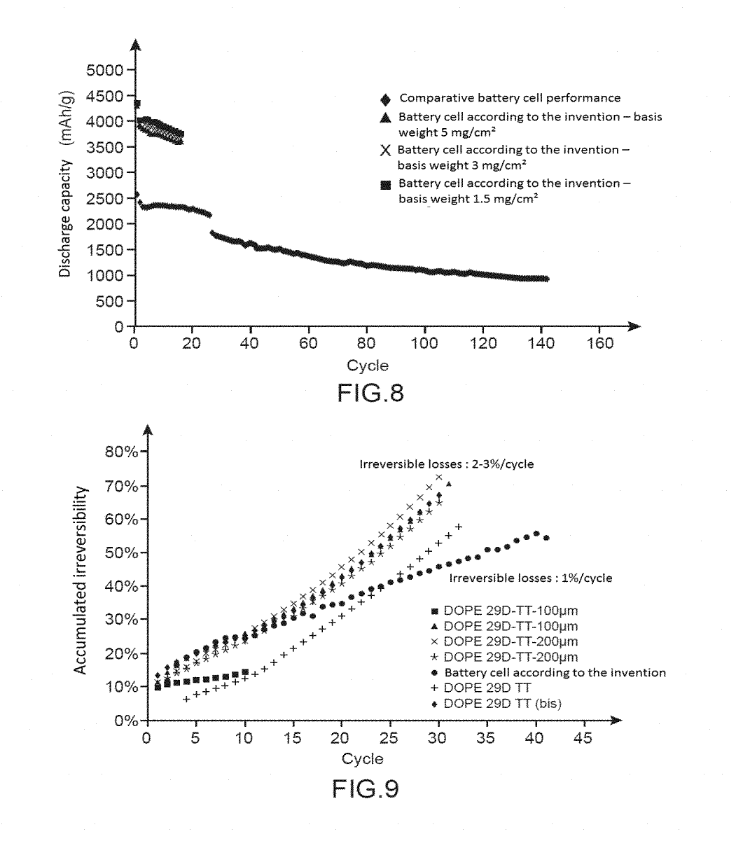

In FIG. 8, the specific capacity (in mAh/g) in discharge (rhombus markers ♦) is also given versus the number of cycles during the test (Example 4) according to C/20 cycling of a comparative button cell such as the one illustrated in FIG. 7, the positive electrode of which consists of lithium metal and the negative electrode of which has not been prepared by the method according to the invention, but by a method in which the ink is not cross-linked with cations, the ink is dried at room temperature and not by freeze-drying, and in which the dried ink is then heat treated.

FIG. 9 is a graph which gives the accumulated irreversible losses for respectively a button cell as the one illustrated in FIG. 7 (round markers ●), the positive electrode of which consists of lithium metal and the negative electrode of which is an electrode according to the invention prepared in Example 3, and for comparative button cells comprising negative electrodes prepared by a method non-compliant with the invention from the following materials:
DOPE 29D TT-100 μm (▪ or ▴ markers),
DOPE 29D TT-200 μm (X or * markers),
DOPE 29D TT (+ markers),
DOPE 29D TT bis (♦ markers).

In ordinates is plotted the accumulated irreversible loss (in %), and in abscissas is plotted the number of cycles.

### DETAILED DESCRIPTION OF PARTICULAR EMBODIMENTS

The following detailed description is rather made in connection with the method according to the invention for preparing an electrode according to the invention, but it also contains teachings which apply to the electrodes according to the invention as such.

As a preamble to this detailed description, first of all we specify the definition of some of the terms used herein.

The viscosities are generally measured at 20° C.

By «nano-objects», is generally meant any object alone or bound, attached, to a nanostructure for which at least one dimension is less than or equal to 500 nm, preferably less than or equal to 300 nm, still preferably less than or equal to 200 nm, better less than or equal to 100 nm, for example is in the range from 1 to 500 nm, preferably from 1 to 300 nm, still preferably from 1 to 200 nm, better from 1 to 100 nm, even better from 2 to 100 nm, or even from 5 to 100 nm.

These nano-objects may for example be nanoparticles, nanowires, nanofibers, nanocrystals, or nanotubes.

By «submicron object» is generally meant any object for which the size, such as the diameter in the case of a spherical or spheroidal object, is less than 1 μm, preferably is from 50 nm to 800 nm, for example 310 nm.

By «nanostructure» is generally meant an architecture consisting of an assembly of nano-objects and/or submicron objects which are organized with functional logic and which are structured in a space ranging from one cubic nanometer to one cubic micrometer.

By «polysaccharide», is generally meant a polymeric organic macromolecule consisting of a chain of monosaccharide units. Such a macromolecule may be represented by a chemical formula of the form —[Cₓ(H₂O)_{y}]ₙ—.

As this is specified below, according to the invention, macromolecules consisting of mannuronic acid (M unit) and of guluronic acid (G unit) are preferably used.

The macromolecular chains most adapted to the invention are those which maximize the M units (i.e. the M units/G units ratio is greater than 60%).

This description generally refers more particularly to an embodiment in which the electrode prepared by the method according to the invention is the positive or negative electrode of a rechargeable lithium-ion accumulator, battery, but it is quite obvious that the description which follows may easily be extended and adapted, if necessary to the preparation of other electrodes.

In the following description, for the sake of simplification, a method for preparing an electrode is more particularly described, wherein the composite material applied for manufacturing this electrode is a material comprising carbon nanotubes and nanoparticles or submicron particles of an active material or active matter of a negative or positive electrode active material with lithium-ions (designated hereafter as «active material») such as silicon, LiFePO₄, LiMnPO₄, LiNiPO₄, but it will be understood that this description generally applies to a method for preparing an electrode in which the composite material applied for manufacturing this electrode comprises nano-objects made of a first electron conductive material and nano-objects made of a second material different from the first material.

Further, in the following, a method for preparing an electrode is more particularly described, wherein, in the composite material applied for manufacturing this electrode, the nano-objects made of at least one first electron conductive material are marked (labelled) with a first molecule, the nano-objects or the submicron objects made of at least one second material different from the first material are marked with a second molecule, and the nano-objects or submicron objects made of at least one second material are self-assembled and bound, attached, on the nano-objects made of at least one first material by specific recognition between the first molecule and the second molecule.

The man skilled in the art will be easily able to adapt the teachings of the description which follows for preparing electrodes from other composite materials comprising organized nano-objects.

In order to prepare the composite material used in the method according to the invention, the molecular marking of the active material of the nanoparticles or submicron particles of active material is achieved by a second marking molecule.

For this, a solution in a solvent of a second marking molecule is added to the nanoparticles or submicron particles of active material.

As this was seen above, the molecular recognition pair applied according to the invention is not limited and may notably be selected from among specific recognition pairs or molecular recognition pairs already mentioned above.

Preferably, the first molecule is biotin, and the second molecule is avidin or streptavidin and the following description is rather made for convenience with reference to this molecular recognition pair. However the man skilled in the art will understand that this description applies to any molecular recognition pair.

If the active material is silicon, the silicon particles are generally submicron particles, i.e. for which the size such as the diameter is less than 1 μm, for example from 50 nm to 800 nm, still for example 310 nm.

A spherical shape of the silicon particles is recommended for allowing easy insertion of these silicon particles into the entanglement network of the carbon nanotubes.

A silicon powder which particularly suitable for use in the method according to the invention is a submicron spherical silicon powder, for which the particles have a diameter of about 310 nm and which is available from the S′tile Company.

The solvent of this solution of nanoparticles or submicron particles consists generally exclusively of water, any other solvent being excluded. Generally, the water of this solution is deionized («DI» water).

Even if the active materials are generally partly or totally soluble in water, the amount of active material in the solution is such that this solution (i.e. the solution after addition of the protein solution to the powder) is beyond the solubility limit of the active materials in water, and that a dispersion of nanoparticles or submicron particles of active material in water is therefore obtained.

The required volume of water of the solution de protein such as avidin or streptavidin is that of the interstitial volume of the non-packed active material.

The protein mass such as avidin or streptavidin introduced into the solution is generally equivalent to 0.1% to 1% by mass, for example 1% by mass, of the mass of the volume of interstitial water of the non-packed active material.

The dissolution of the protein such as avidin or streptavidin in water is generally carried out with magnetic stirring at room temperature and the water solution containing the protein, such as avidin or streptavidin is then poured into a container containing the powder of nanoparticles or submicron particles of active material. A power of nanoparticles or submicron particles of active material marked with the protein such as avidin or streptavidin is thereby obtained.

A homogenizing mixing is carried out before freeze-drying by freezing, for example at −80° C. of the powder of active material marked with the protein such as avidin or streptavidin.

In order to prepare the composite material used in the method according to the invention, molecular marking of the carbon nanotubes with biotin, which is a water-soluble vitamin, is further achieved.

For this, carbon nano-objects such as carbon nanotubes (CNT) are dispersed in water. In other words, carbon nano-objects are mixed with water.

The solvent of the thereby prepared dispersion consists exclusively of water, excluding any other solvent. Generally, the water of the dispersion is deionized water (“DI” water).

Any additive is banned, and no additive whatever it is added to water, since it is required that in the obtained dispersion, the carbon nanotubes be “away from equilibrium” (“out of equilibrium”).

Carbon nanotubes (“CNT”) may be single-walled carbon nanotubes (“SWCNT”) or multi-walled nanotubes (“MWCNT”) such as double-walled carbon nanotubes (“DWCNT”).

The carbon nanotubes may have an average length from 1 μm to 10 μm, for example 2 μm and an average diameter from 5 nm to 50 nm, for example 20 nm.

The concentration of the carbon nano-objects in the dispersion is generally from 1 to 5 g/L of water, for example 2.5 g/L of water.

For marking with biotin, it is thus possible to use for example a dispersion containing 0.5 g of carbon nanotubes in 500 ml of water (i.e. 0.25 g of carbon nanotubes/L).

The maximum concentration not to be exceeded is estimated to be 5 mg/ml of water for 10 μm tubes.

This dispersion of the carbon nano-objects, such as carbon nanotubes in water, may be achieved by adding the carbon nano-objects to water and then by submitting the carbon nano-objects in water to a mixing, dispersion operation, combining two mixing techniques i.e. a mixing technique with ultrasound and then a high-speed mixing technique.

Preferably, the ultrasonic waves are generated by a probe placed in a container where the carbon nanotubes are positioned in water.

The ultrasonic waves generally have an acoustic power density from 1 to 1,000 W/cm², for example 90 W/cm² and the carbon nano-objects, such as the carbon nanotubes are exposed to the action of the ultrasonic waves for a short period generally from 1 to 100 ms, for example 20 ms. Such a short period gives the possibility of de-agglomerating the carbon nano-objects without breaking them and thus avoids damaging of the carbon nano-objects.

By high speed mixing, is generally meant that the carbon nano-objects in water are accelerated and sheared with a shearing rate from 500 s⁻¹ to 2,000 s⁻¹ and that the velocity of the nano-objects is generally from 1 to 5 m/s, for example 3 m/s.

Such a velocity guarantees optimum de-agglomeration of the carbon nano-objects. Indeed, below 1 m/s and beyond 5 m/s, an agglomeration of the carbon nano-objects generally occurs.

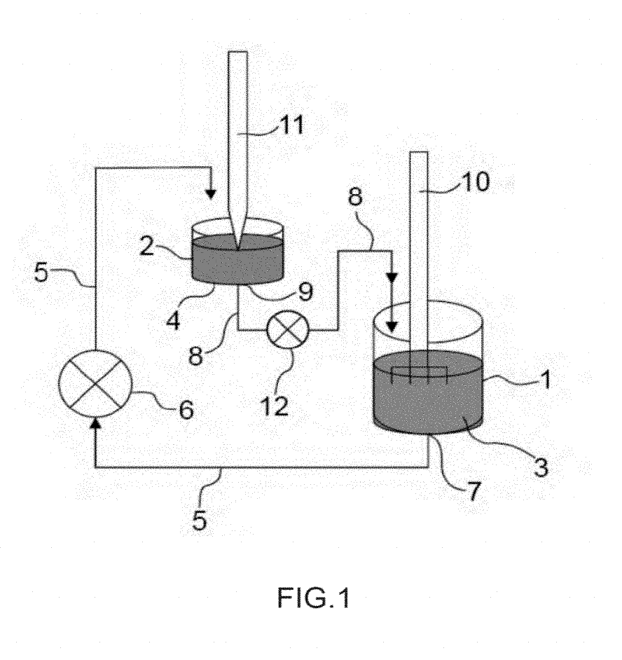

A device which may be applied for carrying out this step is illustrated in FIG. 1.

This device comprises a high-speed mixing tank (1) and an ultrasound reactor (2) specific to this use. The high-speed mixing tank (1) and the ultrasound reactor (2) appear as open cylindrical tanks with circular bases (3, 4).

A first pipe (5), on which is placed a first pump, for example a peristaltic pump (6), connects an orifice (7) located at the centre of the base (3) of the high-speed mixing tank (1) to the top of the ultrasound reactor (2).

A second pipe (8), on which is placed a second pump (12), connects an orifice (9) located at the centre of the base (4) of the ultrasound reactor (2) to the top of the high-speed mixing tank (1).

The diameter of the second pipe (8) is for example 6 mm.

The flow velocity inside this pipe is for example estimated to be 17 m/min for a flow rate of more than 0.5 L/min.

It should be noted that instead of using two pumps, it is possible to use a single pump with two channels for example the pump (6) which is then placed on the pipe (5) and on the pipe (8).

The high-speed tank (1) is equipped with a high-speed stirrer (10), for example of the Ultra Turrax® type.

The mixing technique is a hybridization of the high-speed mixing technique with the ultrasound mixing technique with a probe.

The ultrasonic probe or rod (11) is placed at the centre of the ultrasound reactor (2) facing the orifice, outlet (9) located in the centre of the base (4) of the ultrasound reactor (2).

In order to prepare the dispersion of nano-objects, one begins by positioning water in the mixing tank without actuating the high-speed stirrer, and then the carbon nano-objects such as carbon nanotubes are added to the water. Or else, one begins by positioning the carbon nano-objects in the mixing tank without actuating the high-speed stirrer, and then water is added to them.

A mixture of carbon nano-objects and water is thereby formed.

Or else further, the carbon nano-objects are pre-dispersed, mixed beforehand and then this pre-dispersion, this mixture is placed in the tank (1).

The mixture of water and of nano-objects for example consists of 1.25 g of carbon nano-objects, for example CNTs in 500 ml of deionized water, i.e. the concentration of nano-objects of the mixture is 2.5 mg/ml.

The mixture of water and of nano-objects such as carbon nanotubes is conveyed via the pipe (5) under the action of the pump (6) and arrives in the ultrasound reactor (2).

In the ultrasound reactor, the nano-objects are subject to exposure to the ultrasonic waves emitted by the probe; for example they are subject to an exposure to ultrasonic waves with a frequency of 20 kHz and a power of 250 W for a short period, for example for about 20 ms, which corresponds to about 400 pulses.

This short exposure period to ultrasonic waves ensures that the carbon nano-objects such as CNTs are not damaged, and gives the possibility of de-agglomerating them without breaking them since the energy set into place does not generally exceed 5 Joules.

The mixture of nano-objects and of carbon nano-objects which has been exposed to ultrasonic waves is then set into motion with the peristaltic pump (12) in order to acquire a linear velocity which is sufficient so that the nano-objects do not agglomerate again in the pipe (8) after their passing into the reactor and their exposure to the ultrasonic waves. This linear velocity is at least 10 m/min, and may for example be 17 m/min.

After the ultrasonic reactor (2), the nano-objects thus arrive via the pipe (8) into the high-speed tank (1) where they are accelerated and sheared at a shear rate of for example 1175 s⁻¹.

There also, the nano-objects locally attain a velocity of generally 3 m/s which guarantees optimum de-agglomeration. Below 1 m/s and beyond 5 m/s, agglomeration of the nano-objects such as CNTs occurs.

The preparation of the aqueous dispersion by combination of the mixing technique with ultrasonic waves and the high-speed mixing technique generally lasts for 10 to 60 minutes, for example 30 minutes.

The dispersion is characterized by the presence of agglomerates for which the size is for example comprised between 5 μm and 80 μm.

Therefore there always exist agglomerates of CNTs in the prepared dispersion, which is surprising. CNTs are not entirely networked, but interactions, connections exist between these CNTs, and they surprisingly form agglomerates in which they are bound.

In other words, the water expanse the network of CNTs but interactions between CNTs are actually present.

The purpose of this dispersing of the nanotubes is not to obtain a perfect dispersion, since then the connections between the tubes no longer exist and the result is a statistical condition of the CNT dispersion.

As this has been specified above, the dispersion obtained at the end of the first step contains, in addition to water no other solvent and does not contain any additive for example of the dispersant type, like sodium dodecyl sulfate (SDS), sodium dodecyl benzene sulfate (SDBS), lithium dodecyl sulfate (LDS), trimethylammonium bromide (TTAB), cetyltrimethylammonium bromide (CTAB), sodium deoxycholate (SC), sodium taurodeoxycholate (DOC), Igeal Co890®, Triton X-100® (C₈H₁₇C₆H₄(OC₂H₄)₉₋₁₀OH), and Tween® 20 and 80.

The obtained dispersion consists therefore of carbon nanotubes and water, generally deionized water.

This dispersion is an «out-of-equilibrium» dispersion, only comprising a non-stable phase of CNTs and water, it therefore has to be maintained under stirring and the stirring should not be stopped.

Generally, during all the transfers, the dispersion should always be in motion, should always have kinetic energy, and have a sufficient linear speed as already specified above.

Biotin is then added into the dispersion of carbon nanotubes under magnetic stirring at room temperature so that the vitamin such as biotin, binds, attaches, onto the carbon nanotubes because of the n interactions of the graphene sheets.

The amount of added biotin is generally from 1 to 10 mg/L of dispersion of carbon nanotubes. In other words, the biotin concentration is generally from 0.1% to 1% by mass of the total mass of the dispersion. Thus, 10 mg of biotin may be added for 1,000 mL of dispersion of carbon nanotubes.

The dispersion is then freeze-dried, i.e. it is successively frozen, solidified, and then sublimated.

For this, drops of the dispersion are formed, with a diameter generally from 0.5 to 2 mm, for example of 1 mm, for example by means of a “pilling” system, and these drops are directly dropped into liquid nitrogen in order to thereby obtain by fast freezing, frozen macro-objects or capsules preferably having a spherical shape, such as ice beads, and for which the size, such as the diameter is for example from 0.5 mm to 2 mm, for example 1 mm.

These frozen macro-objects or capsules preferably having a spherical shape such that ice beads contain the expanded carbon nanotubes marked with biotin.

This solidification, freezing, is in fact the first part of the freeze-drying treatment.

This solidification, freezing of the dispersion for obtaining macro-objects, is followed by a sublimation step which constitutes the second part of the freeze-drying treatment.

During this sublimation step, under the effect of vacuum, the frozen solvent, i.e. the ice inside of the macro-objects or capsules is removed and the enzyme such as biotin then marks the surface of the carbon nanotubes.

It should be noted that generally, the term of «marking» (labelling) is rather specific to the adsorption of organic molecules on the carbon nanotubes or the active materials, while the term of «binding» (attachment) is rather suitable, specifically for inorganic active materials which are bound (attached) on the nanotubes playing the role of a support.

Freeze-drying is generally carried out in a high vacuum, i.e. under a pressure not exceeding 5.10⁻³ mbars, for example a pressure from 10⁻³ to 10⁻⁷ mbars and at a temperature not exceeding −20° C., for example a temperature of −80° C.

The duration of the freeze-drying depends on the piece of equipment used and may range for example from 1 h to 12 h per liter of dispersion.

Next, the assembling of the active material powder marked on the carbon nanotubes marked by molecular recognition between biotin and avidin or streptavidin is achieved.

First of all a dispersion consisting of marked carbon nanotubes and water is prepared.

For this, the freeze-dried marked carbon nanotubes prepared earlier are added in a certain volume of water for example 500 mL of water with magnetic stirring, in order to obtain a dispersion of marked carbon nanotubes.

The concentration of carbon nanotubes of this dispersion is generally from 1 to 2.5 mg/L.

The powder of nanoparticles or submicron particles of marked active material is then added to this dispersion of marked carbon nanotubes, always with magnetic stirring.

The amount of nanoparticles or submicron particles of active material such as silicon, is such that the obtained dispersion of carbon nanotubes and of nanoparticles or submicron particles of active material such as the silicon generally contains from 5 to 15 g, for example 8 g, of nanoparticles or submicron particles of active material such as silicon/L of dispersion.

Indeed, beyond 15 g of silicon particles/L of dispersion, self-assembling is generally no longer possible, since the number of silicon particles is too large relatively to the number of carbon nanotubes. The same applies below 5 g of silicon/L of dispersion since there are then too many carbon nanotubes relatively to the silicon particles, and the silicon nanotubes are then put at the surface of the active materials.

The mass ratio of the number of nanoparticles or submicron particles of marked active material such as silicon:number of carbon nanotubes is generally from 60/1 to 99/1, for example 99/1.

The nanoparticles or submicron particles of marked active material such as silicon are generally added at a constant rate, generally in an amount from 10 to 500 mg/min, for example in an amount of 300 mg/min. Thus, if 9 g of active material, such as silicon are added, the duration of the addition will generally be 30 minutes.

The duration of this step during which are maintained the conditions discussed above, i.e. inter alia, the addition of the active material particles such as silicon particles at a constant rate, the shear rate and the high velocity of the fluid is generally from 15 to 60 minutes, for example 30 minutes.

At the end of this step, the self-assembled composite material according to the invention is thereby obtained, which is then separated from the water of the dispersion, and then dried for example by freeze-drying or by drying with supercritical CO₂, and generally appears as a powder.

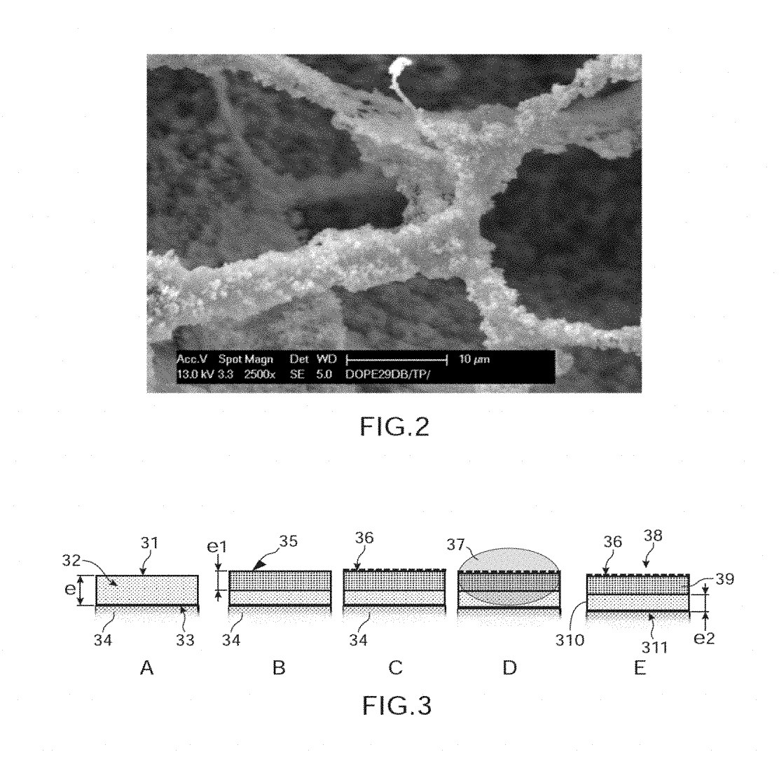

The SEM photograph of FIG. 2 shows a typical image of a self-assembly of silicon nanoparticles on carbon nanotubes by molecular recognition.

The powder of the thereby prepared self-assembled composite material, more simply designated as self-assembled powder, is ready-for-use in order to manufacture an ink and does not require any milling, grinding, which would break the whole organization present in the powder.

The grain size of the self-assembled powder is generally comprised between 1 μm and 100 μm, its specific surface area is generally comprised between 10 m²/g and 50 m²/g, and its density is generally comprised between 2.014 g/cm³ and 2.225 g/cm³. This powder may therefore be described as an “expanded” foamed powder.

The self-assembled powder may be mixed, for example by simple mechanical action with any kinds of materials.

This mechanical action may comprise one or several operations for example, it is possible to only carry out an extrusion; or else it is possible to carry out a simple mechanical mixing; or else it is possible to achieve a simple mechanical mixing possibly followed by drying of the mixture.

The specific organization, the self-assembling, of the carbon nanoparticles and of the nanoparticles or submicron particles of active material, such as CNTs and silicon nanoparticles is preserved after this mechanical action.

According to the method for preparing an electrode according to the invention, a suspension, ink or paste (slurry) is prepared containing the self-assembled composite material by mixing the latter with the materials which make up the carrier, vehicle of this suspension, ink or paste (slurry).

By “carrier of a suspension, ink or slurry”, is generally meant the components, ingredients required for imparting to this ink or slurry and to the marking obtained with this ink or slurry, the desired properties.

The carrier of the ink or paste (slurry) generally comprises a binder, which according to the method of the invention is a polysaccharide, and a solvent.

The carrier may further comprise electron conductive additive(s) different from the self-assembled composite material according to the invention.

The optional electron conductive additive may be selected from metal particles such as Ag particles, graphite, graphene, carbon black, carbon fibers, carbon nanowires, carbon nanotubes, and electron conductive polymers, and mixtures thereof.

Indeed, graphene and carbon fibers may exactly fulfill the same role as graphite in the ink.

Only the large scale organization will be different depending on the nature of the contemplated electron conductor like carbon fibers or micrometric graphite.

The ink may be an ink with an aqueous base, i.e. the solvent of which in majority comprises water, preferably consists of water, in other words, for which the solvent comprises 50% of water or more by volume, preferably consists of water, i.e. comprises 100% of water by volume.

Or else, the ink may be an ink with an organic base, i.e. for which the solvent in majority comprises one or several organic solvent(s) or consists of one or several organic solvent(s), for example a so called fatty base ink for which the solvent consists of one or several drying oils; an ink based on a silica or carbon sol-gel.

As regards the binder of the ink, indeed there does not exist any limitation as to the polysaccharide macromolecule and all the molecules belonging to the family of polysaccharides may be used in the method according to the invention. These may be natural or synthetic polysaccharides.

Indeed, as the organization, for example the self-assembling of the nanopowders of the composite material according to the invention is carried out upstream from the manufacturing of the ink, it is possible to use any polysaccharide as an binder for this ink and for the electrode prepared from the latter.

The polysaccharide macromolecule may notably be selected from among pectins, alginates, alginic acid, and carrageenans.

By “alginates”, is meant both alginic acid and the salts and derivatives thereof such as sodium alginate. The alginates and notably sodium alginate are extracted from various brown algae Phaeophyceae, mainly Laminaria such as Laminaria hyperborea; and Macrocystis such as Macrocystis pyrifera. Sodium alginate is the most common marketed form of alginic acid.

Alginic acid is a natural polymer of raw formula (C₆H₇NaO₆)ₙ consisting of two monosaccharide units: D-mannuronic acid (M) and L-guluronic acid (G). The number of base units of the alginates is generally of about 200. The proportion of mannuronic acid and of guluronic acid varies from one species of algae to the other and the number of units M to the number of units G may range from 0.5 to 1.5, preferably from 1 to 1.5.

The alginates are linear non-branched polymers and are not generally random copolymers but depending on the alga from which they stem, they consist of sequences of similar or alternating units, i.e. sequences GGGGGGGG, MMMMMMMM, or GMGMGMGM.

For example, the M/G ratio of the alginate from Macrocystis pyrifera is of about 1.6 while the M/G ratio of the alginate from Laminaria hyperborea is of about 0.45.

From among the polysaccharide alginates from Laminaria hyperborea, mention may be made of Satialgine SG 500, from among the polysaccharide alginates from Macrocystis pyrifera of different molecule lengths, mention may be made of the polysaccharides designated as A7128, A2033 and A2158 which are generic derivatives of alginic acids.

The polysaccharide macromolecule applied as a binder in the method according to the invention generally has a molecular mass of 80,000 g/mol to 500,000 g/mol, preferably 80,000 g/mol to 450,000 g/mol.

Preferably, the solvent is water, and the solvent and the binder therefore appear as an aqueous gel or hydrogel of polysaccharide, such as an alginate hydrogel.

The incorporation of the composite material described above into this mixture is preferably carried out by a mixing technique without any milling, grinding, in a mixing apparatus, for example of the planetary mixer type, not causing any milling, and setting into play a very low energy, i.e. generally less than 100 Joules/revolution, in order to preserve the self-assembly of the carbon nanotubes with the nanoparticles or submicron particles of active material such as silicon which is preserved at 60 J/revolution.

Such a mixing apparatus gives the possibility of avoiding the formation of lumps, and gives the possibility of retaining an ink fineness of less than 10 μm.

It is therefore possible with this technique and this apparatus, to intimately mix the self-assembled powder of carbon nanotubes and of nanoparticles or submicron particles of active material, such as silicon, with its carrier, such as an alginate hydrogel, by adjusting the viscosity with water in order to attain for example the value of 1 Pa·s at a shear rate of 1 s⁻¹ and a grain size fineness of less than 10 μm.

For example, it is possible to begin by introducing into the planetary gear mixer the alginate gel at a concentration generally from 6% to 10% by mass, for example 8% by mass, and then the self-assembled powder of carbon nanotubes and of nanoparticles or submicron particles of active material, such as silicon, with optionally its electron conductor.

The rotational speed is slow, for example approximately 100 rpm and the pressure is for example of 2 bars on the plate.

The suspension, paste (slurry) or ink, may have a dry extract greater than or equal to 70%, preferably from 70% to 90%, and a viscosity at rest greater than or equal to 500 Pa·s, preferably from 500 Pa·s to 700 Pa·s.

The composition of the ink as a dry extract is generally from 60% to 90% by mass, for example 85% by mass of self-assembled active material, at from 0.5% to 5% by mass, for example 1% by mass of carbon nanotubes, bound, attached to from 5% to 20% by mass, for example 14% by mass of polysaccharide, preferably alginate.

Advantageously, the suspension, paste (slurry) or ink may have a dry extract greater than or equal to 70%, preferably from 70% to 90%, and a viscosity at rest greater than or equal to 500 Pa·s, preferably from 500 Pa·s to 700 Pa·s.

According to the method for preparing an electrode according to the invention (see FIG. 3), this suspension, paste (slurry) or ink is not directly deposited, coated or printed on a current collector, but on a first face (31) of a sheet, plate, made of a porous cellulose material (32) comprising a first face (31) and a second face (33) separated by a thickness (e) (FIG. 3A).

The thickness of said sheet or plate (32) is generally from 10 μm to 100 μm.

By cellulose material, is generally meant a material comprising more than 50% by mass of cellulose, or even 100% by mass of cellulose notably of cellulose fibers or microfibers.

This cellulose material may notably be paper, preferably blotting paper, consisting of cellulose microfibers.

The blotting paper sheet generally has a thickness of 180 μm and its basis weight is of the order of 80 g/m².

The blotting paper does not comprise any additive, in particular no binder, and its mechanical strength is guaranteed by the interactions of the cellulose microfibers which make it up.

In order to achieve coating with the ink, the sheet, plate, made of a cellulose material for example the blotting paper sheet is positioned on a supporting plate (34) for example a glass plate which itself is positioned on the coating table.

The viscosity of the ink used in the method for preparing an electrode according to the invention is adjusted at rest so that the sheet absorbs the ink exclusively on a portion (e1) of its total thickness, for example half of its total thickness (FIG. 3B).

For example, the viscosity of the ink may be adjusted between 500 Pa·s and 700 Pa·s so that the blotting paper sheet exclusively absorbs on half of its total thickness of 180 μm.

The coating of the ink (35) on the first face, upper face (31), of the sheet is generally achieved with a basis weight of more than 2 mg/cm² preferably from 1 m²/g to 5 m²/g.

The deposition, coating of the ink may be achieved with any adequate method such as sizing, coating, roto gravure, flexography, offset printing.

The thickness of the deposited, applied ink, paste (slurry), or suspension is generally from 50 to 300 μm, for example 100 μm.

As soon as the end of the deposition, coating, and without awaiting drying, the current collector (36), is then applied, pressed against, on the coated surface of the sheet, for example of the blotting paper sheet (FIG. 3C).

The current collector (36) may appear as a sheet or a grid of an electrically conducting metal, for example made of copper, aluminium or nickel.

The grid, for example made of copper or aluminium is partly embedded, inlaid in the coated ink, at the interstices of the grid.

A cross-linking, gelling aqueous solution (37) is then poured in excess on the grid, for example made of copper or made of aluminium, of the collector (FIG. 3D).

This solution is a solution of at least one salt soluble in water, which may release into the solution cations selected from among monovalent, divalent and trivalent cations.

The divalent cations may be selected from among Cd²⁺, Cu²⁺, Ca²⁺, Co²⁺, Mn²⁺, Fe²⁺, and Hg²⁺. Preferred divalent cations are Ca²⁺ cations.

Monovalent cations may be selected from among Li⁺, Na⁺, K⁺, Rb⁺, Cs⁺, Ag⁺, Ti⁺, and Au⁺.

Trivalent cations may be selected from among Fe³⁺, and Al³⁺.

The anion of the salt(s) may be selected from among nitrate, sulfate, phosphate halide such as chloride, bromide ions.

The solution may only comprise one single salt or else it may comprise several salts.

Advantageously, the solution comprises several salts so that a mixture of cations may be released into the solution.

For example, the solution comprises a mixture of salts which may release in the solution a mixture of cations comprising at least one monovalent cation, at least one divalent cation and at least one trivalent cation.

A preferred solution comprises calcium ions in deionized water DI in the form of a calcium salt such as CaCl₂, at a concentration from 1 to 10 g/L.

An example of such a solution is a solution for example consisting of 10 g of CaCl₂ in 11 of deionized water DI.

The solution penetrates into the electrode through the meshes of the grid and gels, cross-links the polysaccharide, such as an alginate, as far as the core of the electrode, more exactly on the portion of the total thickness of the sheet made of cellulose material, in which the ink has been absorbed.

The supporting plate (34), for example made of glass, comprising a sheet made of a cellulose material in which the ink has been absorbed on a portion of the thickness, and the polysaccharide, such as an alginate, has been gelled, cross-linked, and in which a grid, for example of copper or aluminium is embedded, is then subject to a freeze-drying treatment i.e. freezing followed by sublimation (FIG. 3E).

The conditions under which this freeze-drying treatment may be achieved have already been described above.

The freezing may for example be carried out at a temperature of −80° C.

The gelling by the cations, such as calcium cations, produces stratification of the electrode by the so called “egg box” mechanism of the polysaccharide such as an alginate.

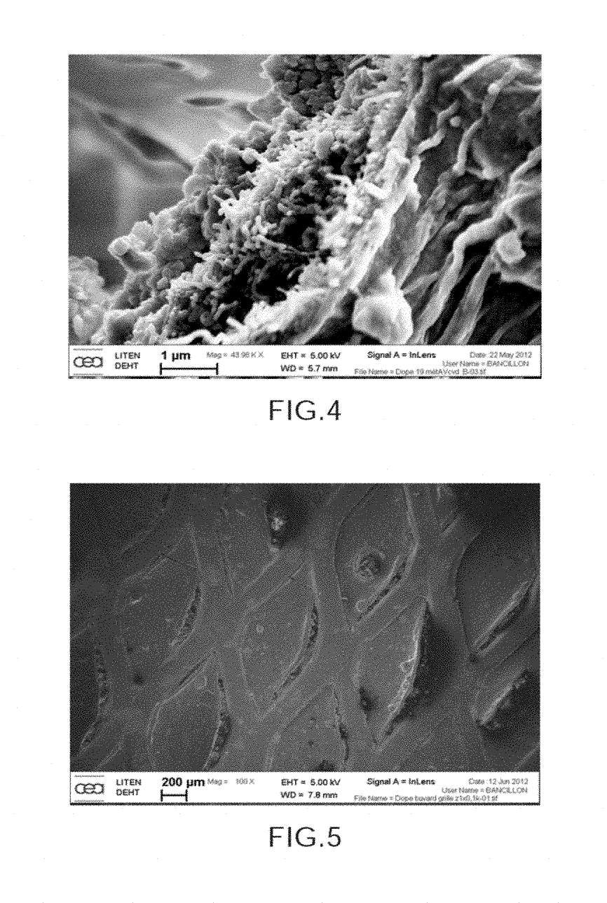

The photograph of FIG. 4 shows such a stratification obtained by gelling and freeze-drying an ink inside a cellulose reinforcement of the blotting paper type, the ink containing silicon particles self-assembled by molecular recognition on the CNTs.

The electrode is then separated from the supporting plate, for example made of glass.

As this is shown in FIG. 5 and in FIG. 3E, the electrode comprises a collector face, side (38), with the grid forming a collector (36), for example made of copper or made of aluminium deposited on a first face (31) of a sheet made of a cellulose material and immobilized on this first face (31) by the gelled ink absorbed in the sheet of cellulose material. Under the grid, gelled ink (39) containing the composite material according to the invention is absorbed in the cellulose material of the sheet on (over) a portion (e1) of the thickness of the latter for example on (over) half of the thickness of the latter.

The remainder (310) of the thickness of the sheet (e2), as far as the second face (33) of the latter, does not contain any absorbed gelled ink in the cellulose material and therefore plays the role of a separator (separator face 311).

FIG. 5 shows such an electrode with a collector formed by a copper grid embedded at the surface of a cellulose reinforcement, more exactly of a blotting paper sheet. The grid is embedded into the gelled cross-linked ink, at the surface of the sheet.

The basis weight of the thereby prepared electrode is greater than 1.5 mg/cm² of active material, for example from 0.5 to 3 mg/cm² of active material.

The low density of the cellulose reinforcement generally less than or equal to 80 g/m² and without any binder gives the possibility of obtaining basis weights down to 10 mg/cm² by retaining great flexibility of use without cracking of the electrode.

The electrode, generally comprises from 70% to 94% by mass of electrochemically active material, from 1% to 20% by mass, preferably from 1% to 10% by mass of the binder, and optionally from 1% to 15% by mass of the electron conducting additive(s).

It is not proceeded with a carbonization treatment of the electrode.

The electrochemical system, in which is applied the electrode according to the invention may notably be a rechargeable electrochemical accumulator, battery, with a non-aqueous electrolyte such as a lithium accumulator or battery, and more particularly a lithium ion accumulator, battery.

In addition to the positive or negative electrode according to the invention, such an accumulator, battery, may comprise a negative or positive electrode which is not prepared by the method according to the invention.

The negative or positive electrode, which is not prepared by the method according to the invention may comprise an electro-chemically active material different from that of the electrode according to the invention, a binder, optionally one or several electron conductive additives and a current collector.

The optional electron conducting additive(s) is (are) known to the man skilled in the art, and may notably be selected from the electron conducting additives already described above. The binder may be selected from among binders known to the man skilled in the art.

The electro-chemically active material of the negative or positive electrode which is not prepared by the method according to the invention, may be selected from among all the materials known to the man skilled in the art.

Thus, when the electrode according to the invention is the negative electrode, then the electro-chemically active material of the positive electrode may be selected from lithium metal or any material known to the man skilled in the art in this technical field.

The electrolyte may be solid or liquid.

When the electrolyte is liquid, it consists for example of a solution of at least one conductive salt such as a lithium salt in an organic solvent and/or an ionic liquid.

When the electrolyte is solid, it comprises a polymeric material and a lithium salt.

The lithium salt may be selected for example from among LiAsF₆, LiClO₄, LiBF₄, LiPF₆, LiBOB, LiODBF, LiB(C₆H₅), LiCF₃SO₃, LiN(CF₃SO₂)₂ (LiTFSI), LiC(CF₃SO₂)₃ (LiTFSM).

The organic solvent is preferentially a solvent compatible with the constituents of the electrodes, relatively scarcely volatile, aprotic and relatively polar. For example mention may be made of ethers, esters and mixtures thereof.

The ethers are notably selected from among linear carbonates such as dimethyl carbonate (DMC), diethyl carbonate (DEC), methylethyl carbonate (EMC), dipropyl carbonate (DPC), cyclic carbonates like propylene carbonate (PC), ethylene carbonate (EC), and butylene carbonate; alkyl esters like formates, acetates, propionates and butyrates; gamma butyrolactone, triglyme, tetraglyme, lactone, dimethylsulfoxide, dioxolane, sulfolane and mixtures thereof. The solvents are preferentially mixtures including EC/DMC, EC/DEC, EC/DPC and EC/DMC.

The accumulator, battery, may notably have the shape of a button cell.

The various elements of a button cell made of stainless steel 316L, are described in FIG. 7.

These elements are the following:
the upper (105) and lower (106) portions of the stainless steel casing,
the polypropylene gasket (108),
the stainless steel shims (104), which are used for example both for cutting out the lithium metal and then later on for ensuring good contact of the current collectors with the external portions of the cell,
a spring (107), which ensures the contact between all the elements,
a microporous separator (102) impregnated with electrolyte,
electrodes (101) (103).

The invention will now be described with reference to the following examples given as an illustration and not as a limitation.

### EXAMPLES

### Example 1

In this example, a composite material is prepared comprising silicon nanoparticles and carbon nanotubes by the method as described above.

The first manufacturing step is the molecular marking of the silicon nanoparticles.

The amount of silicon nanoparticles is such that the solution (i.e. the solution containing the active material: the silicon nanoparticles, deionized water, and the protein: avidin or streptavidin) is beyond the solubility limit.

In order to mark these silicon nanoparticles, avidin or streptavidin are used. The required volume of water is that of the interstitial volume of the non-packed silicon nanoparticles.

The mass of avidin or streptavidin introduced into the solution is equivalent to 1% of the mass of the interstitial water volume.

Dissolution is carried out with magnetic stirring at room temperature and the solution of water containing avidin (or streptavidin) is then poured into the container containing the powder.

A homogenizing mixing is carried out before freezing at −80° C. and the freeze-drying of the marked active material powders.

The second manufacturing step is the molecular marking of the carbon nanotubes with biotin, a water-soluble vitamin.

The powdered carbon nanotubes are put into solution at a concentration of less than 5 mg/ml of water.

For the marking with biotin, a solution, dispersion, containing 0.5 g of carbon nanotube in 500 mL of water is applied.

The carbon nanotubes are dispersed by applying mixed stirring by ultrasonic waves and by high shearing rate (of the Ultra-Turrax® type). The facility allowing such mixed stirring to be achieved is described in FIG. 1.

10 mg of biotin are introduced into the solution of CNTs with magnetic stirring at room temperature so that biotin binds onto the carbon nanotubes via n interactions of the graphene sheets.

The solution is then passed into a «pilling» system in order to form drops with a diameter of about 1 mm which directly fall into a container of liquid nitrogen so that fast freezing occurs.

The ice beads containing the expanded and biotin-marked carbon nanotubes are then freeze-dried so that the biotin is bound onto the surfaces of the carbon nanotubes.

The third step is the step for assembling the powder of marked silicon nanoparticles on the marked carbon nanotubes by molecular recognition between avidin and biotin.

For this, the marked nanotubes are poured into 500 ml of water with magnetic stirring and then the marked active materials are poured into the water.

The mass proportion of silicon nanoparticles/CNTs is 99/1.

The SEM photograph of FIG. 2 shows a typical image of a self-assembly of silicon nanoparticles on carbon nanotubes by molecular recognition.

### Example 2

In this example, an ink is prepared intended to be applied in the method according to the invention by means of a planetary mixer described above.

One begins by introducing on the planetary mixer a gel alginate at 8% and then the self-assembled active material prepared in Example 1 with its electron conductor such as carbon black, or carbon fibers of type VGCF.

The speed of rotation is slow, approximately 100 rpm and the pressure is of 2 bars on the plate.

The composition of the ink as a dry extract is 85% of self-assembled active materials with 1% of CNTs bound to 14% of alginate.

### Example 3

In this example, negative electrodes are prepared with the method according to the invention.

These electrodes are three in number and have basis weight of 1.5; 3; and 5 mg of active material respectively (by active material is only meant silicon)/cm². First of all, it is preceded with coating, on the first face of a sheet of a blotting paper of format A4, of an ink manufactured like in Example 2, to a thickness of 500 μm (FIG. 3B).

Depending on the basis weight of active material of the electrode which it is desired to prepare, the concentration of active material of the ink is adapted.

The blotting paper has a thickness of 180 μm and its basis weight is of the order of 80 g/m² and it does not contain any binder.

A blotting paper sheet is positioned on a glass plate which is placed on the coating table.

The viscosity of the ink is adjusted at rest between 500 Pa·s and 700 Pa·s so that the blotting paper exclusively absorbs on half of its total thickness of 180 μm. As soon as the end of the coating process and without waiting for drying, the current collector consisting of a copper grid is then applied on the coated surface of the blotting paper (FIG. 3C). The copper grid is partly embedded into the ink which infiltrates into the interstices of the grid.

An aqueous cross-linking solution consisting of 10 g of CaCl₂ in 1 L of deionized water DI is then poured in excess on the copper grid (FIG. 3D).

The solution penetrates into the electrode through the meshes of the grid and gels the ink as far as the core of the electrode, more exactly up to half the total thickness of the sheet.

The glass plate is then frozen to −80° C. and freeze-dried (FIG. 3E).

The gelling by the calcium produces a stratification of the electrode by the so called “egg box” mechanism of the alginate.

This mechanism is based on the fact that the alginate macromolecules with a planar zig-zag conformation are stacked on each other on the CO⁻ sites of the alginate with the cations Ca²⁺ as counter-ions. The Ca²⁺ ions act like elements for assembling an alginate macromolecule on another alginate macromolecule.

The photograph of FIG. 4 shows such a stratification obtained with silicon particles self-assembled on carbon nanotubes.

The current collector formed by the copper grid (or aluminium grid) embedded into the integrated electrode thereby prepared according to the invention, is shown in FIG. 5.

The portion of the thickness of the blotting paper sheet from the first face of the latter in which the ink has been absorbed and gelled and then freeze-dried constitutes the electrode portion, strictly speaking, of the integrated electrode according to the invention. This electrode portion includes the current collector which is supported by the first face and which is embedded in the gelled and freeze-dried ink.

The other portion of the thickness of the blotting paper sheet, from the second face of the latter, in which the ink has not been absorbed plays the role of a separator.

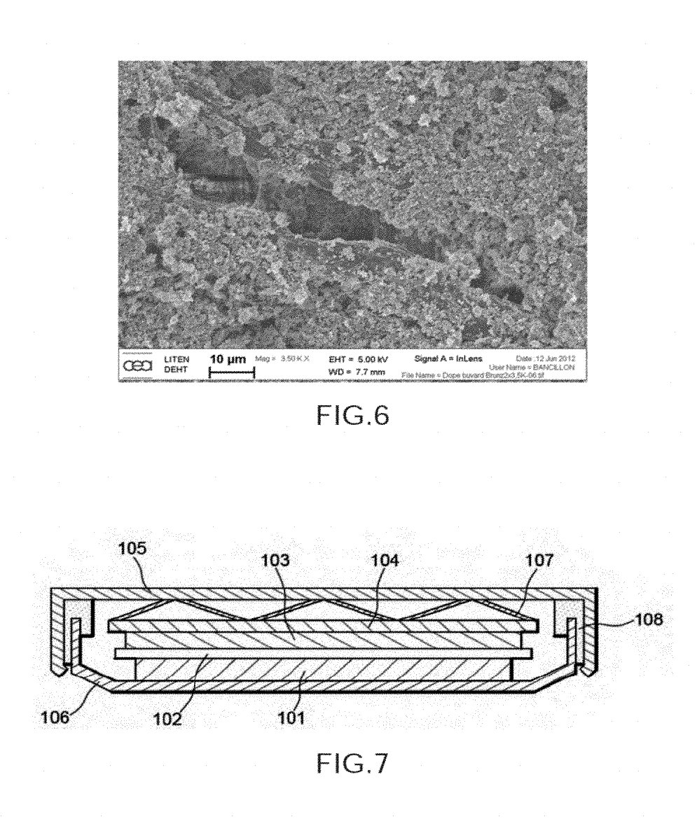

FIG. 6 shows the structure of the thereby obtained electrode according to the invention.

According to the operating procedure described above, three electrodes are prepared which have respective basis weights of 1.5; 3; and 5 mg of active material/cm².

It is then proceeded with cutting out of the sheet.

### Example 4

In this example, the negative electrodes prepared in Example 3 are tested in a lithium metal battery (Half-cell test) of the button cell type.

Each button cell is mounted by carefully observing the same procedure.

Are thus stacked from the bottom of the casing of the cell, as this is shown in FIG. 7:
a negative electrode according to the invention (diameter 14 mm, thickness 100 μm) (101);
150 μL of liquid electrolyte based on the LPF₆ salt in an amount of 1 mol/L, in solution in a 1/1 mixture by mass of ethylene carbonate and dimethyl carbonate, but any other non-aqueous liquid electrolyte known in the art may be used;
the electrolyte impregnates the portion forming a separator (102) of the negative electrode according to the invention;
a positive electrode (103) consisting of a disc with a diameter of 14 mm made of lithium metal;
a disc or shim made of stainless steel (104);
a lid made of stainless steel (105) and a bottom made of stainless steel (106);
a stainless steel spring (107) and a polypropylene gasket (108).

The stainless steel casing is then closed by means of a crimping tool, making it perfectly impervious to air.

In order to check that the cells are operational, the latter are checked by measuring the voltage drop.

Because of the strong reactivity of lithium and of its salts to oxygen and water, the mounting of the button cell is accomplished in a glove box. The latter is maintained with slight overpressure under an anhydrous argon atmosphere. Sensors give the possibility of continuously monitoring the oxygen and water concentration. Typically, these concentrations should remain less than 1 ppm.

Each of the button cells prepared according to the procedure described above undergoes cycles, i.e. charging and discharging processes under different constant current conditions, for a determined number of cycles, in order to evaluate the practical capacity of the cell. For example, a cell which charges under C/20 conditions is a battery to which a constant current is imposed for 20 hours with the purpose of recovering the whole of its capacity C. The value of the current is equal to the capacity C divided by the number of charging hours, i.e. in this case 20 hours. The capacity is 8.5 mAh. The formation at room temperature is carried out at C/20 for 5 hours and C/10 up to 4.2V.

After this step, «floating» is carried out at C/100 before a rest of 5 minutes. The formation is ended by pre-charging at C/5 up to 2.5V. The cycling is at 20° C. at C/20 to 100% of the capacity.

The results of this cyclability tests carried out with cells comprising negative electrodes according to the invention are plotted on the graph of FIG. 8.

In this graph, the results of a cyclability test carried out under the same conditions as those described above have also been plotted, but with a comparative cell comprising a comparative electrode which was not prepared by the method according to the invention, i.e. an electrode prepared in the following way:
One begins by preparing a silicon nanoparticles/carbon nanotubes composite material.

This composite material appears as a self-assembled powder having a characteristic bunches of grapes-like structure.

1.25 g of carbon nanotubes are weighed and poured into 500 ml of deionized water, in a beaker of 2 liters.

The nanotubes are nanotubes of the brand Graphistrength® available from ARKEMA®. These are multi-walled nanotubes with a purity of more than 90%, with an average diameter between 10 nm and 15 nm, and an average length of 7 μm. The specific surface area of these nanotubes is comprised between 20 m²/g and 70 m²/g.

The initial grain size is comprised between 10 μm and 100 μm in majority as entangled nanotubes and forming agglomerated balls.

The beaker is placed under a high speed disperser of the Ultra-Turrax® type adjusted to 2,000 rpm.

Silicone pipes are then used for connecting the beaker to the inlet of an ultrasound reactor by passing through the first channel of a peristaltic pump (which includes 2 channels), and connecting the outlet of the reactor to the beaker via the second channel of the peristaltic pump.

The peristaltic pump is adjusted to 200 rpm which amounts to a circulation velocity of 0.77 liters/min of solution of CNTs.

The mixing period is 30 minutes.

The pump and the ultrasound system are stopped, and only the high speed stirring is maintained at 2,000 rpm.

8.75 g of silicon are then added to the solution or rather the dispersion at a rate of 250 mg/min.

The silicon is in the form of a powder available from the S′tile Company.

The initial grain size is 310 nm.

The powder consists of practically spherical particles with small agglomerates with a size comprised between 1 μm and 5 μm.

The surface area of the powder is estimated to be 14 m²/g.

The operation lasts for 35 minutes before the dispersion is diluted twice with deionized water, and 6 g of alginate as a powder are added inside the vortex.

The alginate is a commercial alginate manufactured by CIMAPREM®.

The grade, the quality, used is CIMALGIN® 80/400.

The grain size of the alginate powder is comprised between 100 μm and 300 μm.

The addition frequency is 200 mg/min for 30 minutes.

The self-assembling into «bunches of grapes» is accomplished during this step.

The stirring at 2,000 rpm is maintained during which it is proceeded with the emptying of the solution for which the total volume is 1 litre.

The emptying is carried out dropwise in liquid nitrogen.

The practically instantaneous freezing of the solution drops set the grape cluster-like organization.

The self-assembling of the silicon nanoparticles on the network of CNTs is carried out during the freeze-drying of the «drops» of ice.

The conditions of the freeze-drying are a temperature of −90° C. with a vacuum of 0.002 mbars.

The duration of this operation is 8 hours.

The electron conduction and the rigidification of the self-assembly in bunches of grapes is carried out by carbonization of the freeze-dried powder.

To do this, the freeze-dried powder is placed in quartz crucibles, and two primary, rough, vacuum cycles are carried out in a horizontal oven, with successive fillings of 2% hydrogenated argon.

The temperature cycle is a rise in temperature from room temperature up to 600° C. at a rate of 20° C./min, followed by a plateau at 600° C. for one hour.
A negative electrode is then prepared with the composite material prepared as described above.

One begins by preparing an ink comprising 1.5 g of the composite material, and a carrier consisting of 1.875 g of an aqueous 8% alginate hydrogel corresponding to 0.15 g of alginate.

The alginate is a commercial product from CIMAPREM® of reference CIMALGIN500®.

The alginate gel is obtained by extrusion in a twin-screw extruder (Prism® Extruder) of 100 g of alginate with 1,250 g of water. Such an extrusion method was retained since it allows maximization of the entanglements.

1.5 g of the self-assembled powder prepared as described above are incorporated into 1.875 g of the alginate gel prepared beforehand by extrusion (92% of water and 8% by mass of alginate extruded beforehand), in order to prepare an ink.

The incorporation of the powder into the alginate gel is carried out by a mixing technique without any milling, grinding, in a mixing apparatus therefore not causing any milling.

Indeed, this incorporation operation is not a milling operation, since the energy set into play is very low, i.e. less than 125 J/revolution in order to preserve the nanostructure constituted by the self-assembling of the carbon nanotubes with the silicon nanoparticles at a scale of less than 10 μm.

The mixing apparatus used gives the possibility of avoiding production of lumps, and gives the possibility of retaining an ink fineness of less than 10 μm.

It is therefore possible with this technique and this apparatus, to intimately mix the self-assembled powder of carbon nanotubes and of silicon nanoparticles with its carrier, i.e. the alginate gel, by adjusting the viscosity with DI (deionized) water in order to attain the value of 1 Pa·s at a shear rate of 1 s⁻¹ and a grain size fineness of less than 10 μm.

Once the homogenization of the self-assembled powder and of the alginate gel has been completed, 0.225 g of carbon fibers VGCF® (“Vapor Grown Carbon Fibers”) from SHOWA DENKO, are incorporated into the ink with the same technique and the same apparatus as those described earlier, by adjusting the viscosity to 1 Pa·s at a shear rate of 1 s⁻¹.

The carbon fibers VGCF® manufactured by SHOWA DENKO have diameters of 150 nm with lengths comprised between 10 μm and 20 μm. The electric resistivity of these fibers is 10⁻⁴ Ω·cm

The carbon fibers VGCF® are used here as an electron conductor in addition to the carbon nanotubes.

Indeed, if inside each bunch of a size of less than 10 μm, there already exists an intrinsic electron conductivity due to the CNTs, it is necessary to generate long distance electron conductivity, i.e. beyond 10 μm, between each bunch.

The carbon fibers VGCF® give the possibility of electronically connecting the bunch-like structure and of providing a long distance conductivity of 10⁻⁴ Ω·cm.

This ink is then coated on a copper current collector at a thickness of 100 μm with a basis weight of 2 mg/cm² and dried at room temperature thereby forming an electrode.

The current collector coated with the dried ink layer is then heat treated at 600° C. for 30 minutes with sweeping of hydrogenated (2%) argon in order to transform the alginate into amorphous carbon. The mass loss does not exceed 30%, which is a low value guaranteeing good cohesion of the electrode and good adherence to the copper sheet.

The electrode (comparative electrode) is then cut out into discs with a diameter of 16 mm and a thickness of 150 μm, i.e. a thickness of 100 μm of ink and a thickness of 50 μm of copper sheet, and these discs are treated with a hydrogen plasma for deoxidizing the silicon and etching the amorphous carbon in order to improve accessibility of the electrolyte to the surfaces of the silicon particles.

It should be noted that this comparative electrode was prepared by a method in which the ink is not cross-linked by cations, the ink is dried at room temperature and not by freeze-drying, and in which the dried ink is then heat treated at 600° C. for 30 minutes with a sweep of hydrogenated (2%) argon in order to transform the alginate into amorphous carbon.

It should be noted that the method according to the invention does not include such a heat treatment step.

It emerges from the graph of FIG. 8 that the accumulators, batteries, (cells) which comprise an electrode according to the invention have a discharge capacity of respectively about 3,400 mAh/g, 3,300 mAh/g, and 3,200 mAh/g for basis weights of 1.5; 3; and 5 mg of active material/cm² respectively while the comparative accumulator, battery, (comparative cell) which comprises an electrode according to the prior art has a discharge capacity close to 2,400 mAh/g.

### Example 5

In this example, the irreversible losses are measured in a lithium metal battery of the button cell type comprising a negative electrode according to the invention prepared in Example 3 (3 mg/cm²).

As a comparison, the irreversible losses are also measured in lithium metal batteries of the button cell type comprising negative electrodes prepared by a method not compliant with the invention from the following materials (see FIG. 9):
DOPE 29D TT-100 μm (markers ▪ or ▴): this material was synthesized according to the method described in applications FR-A1-2 981 643 and WO-A1-2013/060790. The ink was formulated according to Example 2 of these applications and the electrode prepared like in Example 2 of these applications. The coated thickness of the electrode is 100 μm. 2 button cells were manufactured with this material and tested.
DOPE 29D TT-200 μm (markers X or *): this material was synthesized according to the method described in applications FR-A1-2 981 643 and WO-A1-2013/060790. The ink was formulated according to Example 2 of these applications and the electrode prepared like in Example 2 of these applications. The coated thickness of the electrode is 200 μm. 2 button cells were manufactured with this material and tested.
DOPE 29D TT (markers +): this material was synthesized according to the method described in applications FR-A1-2 981 643 and WO-A1-2013/060790. The ink was formulated according to Example 2 of these applications and the electrode prepared like in Example 2 of these applications. The coated thickness of the electrode is 50p.m.
DOPE 29D TT bis (markers ♦): this material was synthesized according to the method described in applications FR-A1-2 981 643 and WO-A1-2013/060790. The ink was formulated according to Example 2 of these applications and the electrode prepared like in Example 2 of these applications. The coated thickness of the electrode is 50 μm.
Cell with an electrode according to the invention (markers ●): prepared in Example 3.

### Reminder of the Preparation of the Electrodes According to Example 2 of the Applications FR-A1-2 981 643 and WO-A1-2013/060790:

The preparation of the negative electrode with this material is performed in two steps: a) Extrusion and refining of the electrode material; b) Coating, drying and calendaring of the negative electrode material.

a) Extrusion and Refining of the Electrode Material:

The extrusion operation is carried out in a twin-screw extruder. This extrusion operation is carried out at room temperature. First of all a 100 g of material according to the invention are placed in a first meter or hopper with which the extruder is provided. Fine powders like 20 g of carbon fibers VGCF (conducting material), 21 g of alginate or of CMC (as binders) are mechanically mixed under dry conditions and placed in the second meter with which the extruder is provided. Both of the meters are positioned on the first transport portion of the extrusion twin-screw. At the first shearing area of the twin-screw, water is introduced with an adjusted flow rate for obtaining a paste (slurry) with a viscosity at rest comprised between 1,000 Pa·s and 10,000 Pa·s. In order to refine the ink and reduce the agglomerates down to a size of less than 10 μm, the material is passed only once in a tri-cylinder the gaps of which have been reduced to a minimum according to the possibilities of the piece of equipment.

b) Coating, Drying and Laying of the Copper Grid:

For an ink viscosity comprised between 10 Pa·s and 100 Pa·s for shearing rates comprised between 10 s⁻¹ and 100 s⁻¹, the coating rate should be comprised between 10⁻³ m/s and 10⁻² m/s for coating thicknesses comprised between 50 μm and 200 μm as specified in the caption of FIG. 9. The viscosity was adjusted to 50 Pa·s, the coating rate is 5.10⁻² m/s for thicknesses of 50 μm, 100 μm and 200 μm.
The coating is made on the cellulose paper of the blotting paper type. Before the ink dries, the grid is directly affixed on the ink impregnated in the cellulose paper. The operation ends with the laying of a cross-linking solution of CaCl₂ (with 15 g/l of CaCl₂ in DI water) for gelling and structuring the electrode. The electrode is then dried at room temperature with a mechanical load not exceeding 0.1 N/mm².

### Procedure for Measuring the Irreversible Losses.

The procedure for measuring the irreversible losses is the following:
The apparatus measures at each charging cycle two quantities NQc (mAh/g) and NQd (mAh/g) respectively corresponding for the negative electrodes to the amount of lithium de-inserted and the amount of lithium inserted into the silicon.
The irreversible amount corresponds to the ratio of lithium irreversibly trapped in the silicon, corresponding to the difference between the quantities NQd-NQc to the quantity NQd of the current cycle. This ratio is plotted as a percentage and is cumulative since at each cycle there is lithium which is irreversibly inserted into the silicon.

It emerges from the graph of FIG. 9 that the accumulator, battery which comprises an electrode according to the invention has only 1% of irreversible losses per cycle while the comparative accumulators have 2 to 3% irreversible losses per cycle.

The accumulator, battery which comprises an electrode according to the invention therefore allows reduction by at least a factor 2 of the irreversible losses.

1-27. (canceled)

28: A method for manufacturing an electrode comprising a composite material comprising nano-objects, the method comprising:
a) positioning a sheet or plate made of a porous cellulose material comprising a first face and a second face separated by a thickness on a supporting plate, the second face being in contact with the supporting plate;
b) preparing a suspension, paste, slurry, or ink comprising a composite material, a polysaccharide, or electron conductive additive(s), and a solvent; the composite material comprising nano-objects made of at least one first electron conductive material and nano-objects or submicron objects made of at least one second material different from the first material; and the nano-objects made of at least one first electron conductive material and the nano-objects or submicron objects made of at least one second material different from the first material being distributed in an organized and non-statistical, non-random way in the composite material;
c) depositing the suspension, paste, slurry, or ink, coated or printed on the first face of the sheet; viscosity of the suspension, paste, slurry, or ink being such that the sheet absorbs the ink exclusively on a portion of its thickness;
d) applying, at an end of c), without waiting for drying of the deposited suspension, paste, slurry, or ink, a current collector on the first face, coated with ink, of the sheet, whereby the current collector is at least partly embedded in the deposited ink;
e) putting the first face, coated with ink, of the sheet, on which the current collector is deposited and embedded, into contact with an aqueous cross-linking solution of the polysaccharide containing at least one salt soluble in water, capable of releasing monovalent, divalent or trivalent cations; whereby the ink is cross-linked, gelled;
f) subjecting the sheet and the supporting plate to a freeze-drying treatment;
g) separating the sheet from the supporting plate.

29: The method according to claim 28, wherein the composite material comprises nanostructures each of the nano-objects made of at least one first electron conductive material on which are self-assembled and bound the nano-objects or the submicron objects made of at least one second material different from the first material, and the nanostructures are homogeneously distributed in the material.

30: The method according to claim 29, wherein the nano-objects made of at least one first electron conductive material are marked with a first molecule, the nano-objects or the submicron objects made of at least one second material different from the first material are marked with a second molecule and are self-assembled and bound on the nano-objects in at least one first material by specific recognition between the first molecule and the second molecule.

31: The method according to claim 30, wherein the first marking molecule and the second marking molecule form a specific recognition pair between molecules, selected from among the (strept)avidin/biotin; protein A/immunoglobulin; protein G/immunoglobulin pairs; the antibody/antigen or antibody/epitope pairs like the peptide poly-His and a specific antibody of this peptide or the C-terminal fragment of the protein Myc and the monoclonal antibody 9E10; the enzyme/substrate pairs like the glutathione S-transferase/glutathione pair; and the nucleotide sequence/complementary nucleotide sequence pairs.

32: The method according to claim 29, wherein each of the nanostructures has a size which is at least equal to a size of each of the nano-objects made of at least one first electron conductive material.

33: The method according to claim 28, wherein the first electron conductive material is selected from carbon, metals, aluminium, copper, metal alloys, aluminium alloys, or copper alloys.

34: The method according to claim 28, wherein the second material is selected from among silicon; metals; tin; metal alloys; sulfur; metal oxides or alumina; positive electrode active materials of lithium-ion accumulators or LiFePO₄, LiFeSO₄F, LiCoO₂, LiNiO₂, LiFeₓMn_{y}PO₄, LiMnₓNi_{y}O₄, LiMnₓNi_{y}Nb_{z}O₄, LiNiₓMn_{y}Al_{z}O₂, LiCoₓNi_{y}Mn_{z}O₂, titanium phosphates, Li₂CoSiO₄, LiMnₓO₄, LiNiₓPO₄, LiCoₓO₂, LiNiₓCo_{y}O₂, sodium, vanadium oxide, TiS₂, TiOₓS_{z}, Li₂MnO₃; and the negative electrode active materials of lithium-ion accumulators, batteries, or graphite, titanates or Li₄Ti₅O₁₂, H₂Ti₁₂O₂₅, Si, Sn, niobium oxides LiₓNb_{y}O_{z}, VBO₃, TiSnSb, Li₂SnO₃, Ni—Si, TiO₂, and SnCo.

35: The method according to claim 28, wherein the nano-objects made of at least one first material are selected from among nanotubes, nanowires, nanofibers, nanoparticles, nanocrystals made of at least one first material, and mixtures thereof; and the nano-objects or submicron objects made of at least one second material are selected from nanotubes, nanowires, nanofibers, nanoparticles, submicron particles, nanocrystals made of at least one second material, and mixtures thereof.

36: The method according to claim 28, wherein the first material is carbon, and the second material is a material other than carbon.

37: The method according to claim 36, wherein the carbon nano-objects are selected from among carbon nanotubes and carbon nanofibers; and the nano-objects or submicron objects made of at least one material other than carbon are silicon nanoparticles or submicron particles.

38: The method according to claim 37, wherein the carbon nanotubes are selected from among single-walled carbon nanotubes, and multi-walled carbon nanotubes or double-walled carbon nanotubes.

39: The method according to claim 36, wherein the nano-objects or the submicron objects made of at least one material other than carbon or silicon nanoparticles or silicon submicron particles have a spherical or spheroidal shape.

40: The method according to claim 28, wherein the first material is aluminium or copper, and the second material is a material other than aluminium or copper or silicon.

41: The method according to claim 28, wherein the ratio of the number of nano-objects or submicron objects made of at least one second material, or silicon, to the number of nano-objects made of at least one first material, or carbon, or carbon nanotubes, is less than or equal to 1/100.

42: The method according to claim 38, wherein the polysaccharide is selected from among pectins, alginates, alginic acid, and carrageenans.

43: The method according to claim 28, wherein the composite material appears as a powder, or an expanded powder.

44: The method according to claim 43, wherein the powder has an average grain size between 1 μm and 100 μm, a specific surface area between 10 m²/g and 50 m²/g, and a density between 2.014 g/cm³ and 2.225 g/cm³.

45: The method according to claim 28, wherein the porous cellulose material is paper, or blotting paper of cellulose microfibers and not containing any additive or a binder.

46: The method according to claim 28, wherein the sheet of porous cellulose material has a thickness from 50 to 500 μm, and a basis weight of less than or equal to 80 g/m².

47: The method according to claim 28, wherein the suspension, paste, slurry, or ink has a dry extract greater than or equal to 70%, and a viscosity at rest greater than or equal to 500 Pa·s.

48: The method according to claim 28, wherein a layer of a suspension, paste, slurry, or ink with a thickness from 100 μm to 1,000 μm, is deposited on the first face of the sheet.

49: An electrode manufactured by the method according to claim 28.

50: The electrode according to claim 49, which is an electrode with an integrated separator.

51: The electrode according to claim 49, which is a negative electrode.

52: An electrochemical system comprising an electrode according to claim 49.

53: The electrochemical system according to claim 52, which is a system with a non-aqueous electrolyte or a rechargeable electrochemical accumulator, battery, with a non-aqueous electrolyte.

54: The electrochemical system according to claim 52, which is a lithium ion accumulator, battery, or a button cell.
